(19) United States
(12) Patent Application Publication
(10) Pub. No.: US 2008/0001123 A1
(43) Pub. Date: Jan. 3, 2008

(54) Luminescent Ink Composition for Organic Electroluminescent Device

(75) Inventors: Tetsuya Inoue, Chiba (JP); Hirofumi Kondo, Chiba (JP); Hidetsugu Ikeda, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: IDEMITSU KOSAN CO., LTD, Chiyoda-ku (JP)

(21) Appl. No.: 11/813,062

(22) PCT Filed: Dec. 26, 2005
(86) PCT No.: PCT/JP05/23712

§ 371 Date: Jun. 28, 2007

(30) Foreign Application Priority Data
Dec. 28, 2004 (JP) 2004-380642

(51) Int. Cl. C09K 11/06

(52) U.S. Cl. 252/301.16

(57) ABSTRACT

A luminescent ink composition for an organic EL device which can form thin films by a wet process easily due to a high solubility of a low-molecular material is provided in order to form an organic thin film containing a luminescent low-molecular material by a wet method with a high productivity. A luminescent ink composition for an organic electroluminescent device comprising: (A) an anthracene derivative represented by the following formula (1); (B) a condensed aromatic ring compound substituted with an arylamino group and/or a styryl derivative substituted with an arylamino group; and (C) an organic solvent.

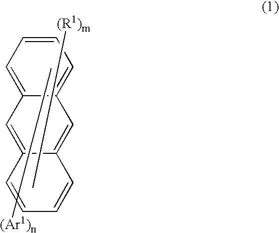

### TECHNICAL FIELD

The invention relates to a luminescent ink composition for organic electroluminescent device used when organic thin films constituting an organic electroluminescent device are formed by a wet method.

### BACKGROUND

An organic electroluminescent (hereinafter “electroluminescent” is abbreviated as “EL”) device is a self-emission type display device which has advantages of having a wide view angle, an excellent contrast, and a quick response time.

An EL device is divided into an inorganic EL device and an organic EL device depending on the type of materials forming an emitting layer. As compared with an inorganic EL device, an organic EL device is excellent in luminance, driving voltage, and response speed characteristics, and can display multiple colors.

In general, the organic EL device includes an emitting layer and a pair of opposite electrodes holding the emitting layer therebetween. When an electric field is applied between the electrodes of this device, electrons are injected from the cathode and holes are injected from the anode. The electrons and the holes recombine in the emitting layer to produce an excited state, and the energy is released (emitted) as light when the excited state returns to the ground state.

An organic EL device using, for example, a low-molecular aromatic diamine and an aluminum metal complex as a material for forming an emitting layer of the organic EL device is reported (see Non-Patent Document 1).

Also, coumarin derivatives, tetraphenylbutadiene derivatives, bisstyrylarylene derivatives, and oxadiazole derivatives are known (see Patent Documents 1 to 3, for example). It is reported that emission of light in the visible range from blue to red can be obtained from these materials. Therefore, a color display device using such materials is expected to be realized.

Further, a device using an anthracene derivative in an emitting layer is reported (Patent Documents 4 to 7, for example). These derivatives, however, have a low luminous efficiency, and hence, a material with a higher luminous efficiency is desired.

In addition, an organic electronic emitting device using a high-molecular compound such as poly(p-phenylenevinylene)(PPV) and poly(2-methoxy-5-(2′-ethylhexyloxy)-1,4-phenylenevinylene is published (Non-Patent Documents 2 and 3).

Further, a soluble PPV into which a functional group is introduced to improve solubility properties for an organic solvent has been developed.

As a result, an emitting layer can be formed by a wet film-forming method such as spin coating and inkjet using a solution containing a PPV derivative, and a device is obtained readily. An organic electronic emitting device using PPV or its derivative as a material for forming an emitting layer realizes emission of various colors ranging from green to orange.

Many of luminescent low-molecular materials which have heretofore been known are hardly soluble. Therefore, an emitting layer is normally formed by vacuum deposition. Vacuum deposition has, however, many disadvantages such as complicated process and need for a large-sized deposition apparatus. The luminescent low-molecular materials have such advantages that they can be produced readily by a shorter synthesis route as compared with PPV, and can be purified to a high purity by a known method such as column chromatography. Therefore, the low-molecular materials can be a luminescent material exhibiting higher emitting performance due to small influences of impurities which are mixed in.

Since the low-molecular materials are expected to enhance the quality of an emitting layer as well as improve the luminous efficiency of an organic EL device, forming a low-molecular material into a film readily by a wet film-forming method has been desired.

As for the technique relating to an ink composition for forming an emitting layer of an organic EL device, Patent Document 8 discloses an organic solvent therefor.

As the low-molecular luminescent material used in a luminescent ink for forming a coating film, an anthracene derivative disclosed in Patent Document 9 is known, for example.

Patent Document 1 JP-A-H8-239655

Patent Document 2 JP-A-H7-138561

Patent Document 3 JP-A-H3-200289

Patent Document 4 U.S. Pat. No. 5,935,721

Patent Document 5 JP-A-H8-012600

Patent Document 6 JP-A-2000-344691

Patent Document 7 JP-A-H11-323323

Patent Document 8 JP-A-2003-308969

Patent Document 9 JP-A-2004-224766

Non-Patent Document 1 Appl. Phys. Lett. 51, 913, 1987

Non-Patent Document 2 Nature, 347,539,1990

Non-Patent Document 3 Appl. Phys. Lett. 58, 1982, 1991

The invention has been made in view of the above-mentioned problems. An object of the invention is to provide a luminescent ink composition for an organic EL device which contains a low-molecular material with a high solubility and can be readily formed into a thin film by a wet process in order to form an organic thin film using a luminescent low-molecular material by a wet method with a high productivity.

### SUMMARY OF THE INVENTION

The invention provides the following luminescent ink composition for an organic EL device and organic EL device.

1. A luminescent ink composition for an organic electroluminescent device comprising:

(A) an anthracene derivative represented by the following formula (1);

(B) a condensed aromatic ring compound substituted with an arylamino group and/or a styryl derivative substituted with an arylamino group; and

(C) an organic solvent 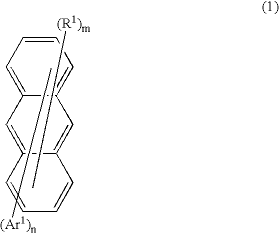
wherein Ar¹ is an aryl group with 6 to 50 nucleus carbon atoms which may have a substituent or a heteroaryl group with 5 to 50 nucleus atoms which may have a substituent;

R¹ is a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group;

n and m are an integer; n+m is 10 or less; and

Ar¹s or R¹s may be the same or different when n or m is 2 or more.

2. The luminescent ink composition for an organic electroluminescent device according to 1 wherein the anthracene derivative is a derivative represented by the following formula (2): 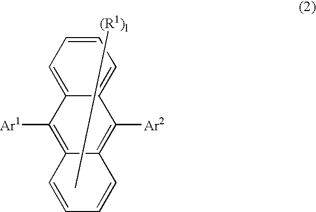
wherein Ar¹ and Ar² are an aryl group with 6 to 50 nucleus carbon atoms which may have a substituent or a heteroaryl group with 5 to 50 nucleus atoms which may have a substituent; Ar¹ and Ar² are different;

R¹ is a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group;

1 is an integer of 0 to 8; and

R¹s may be the same or different when 1 is 2 or more.

3. The luminescent ink composition for an organic electroluminescent device according to 1 or 2 wherein the anthracene derivative is a derivative represented by the following formula (3): 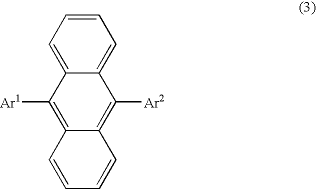
wherein Ar¹ and Ar² are an aryl group with 6 to 50 nucleus carbon atoms which may have a substituent or a heteroaryl group with 5 to 50 nucleus atoms which may have a substituent.

4. The luminescent ink composition for an organic electroluminescent device according to 1 wherein the anthracene derivative is a derivative represented by the following formula (4): 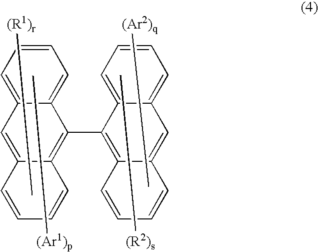
wherein Ar¹ and Ar² are an aryl group with 6 to 50 nucleus carbon atoms which may have a substituent or a heteroaryl group with 5 to 50 nucleus atoms which may have a substituent; Ar¹ and Ar² may be the same or different;

R¹ and R² are a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group; R¹ and R² may be the same or different;

p and q are an integer of 1 to 8; r and s are an integer of 0 to 8; and

Ar¹s, Ar²s, R¹s or R²s may be the same or different when p, q, r or s is 2 or more.

5. The luminescent ink composition for an organic electroluminescent device according to 4 wherein the anthracene derivative is a derivative represented by the following formula (5): 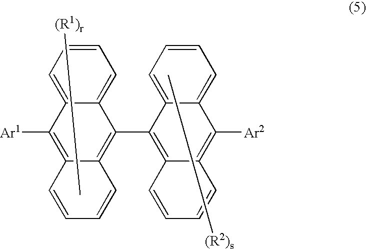
wherein Ar¹ and Ar² are an aryl group with 6 to 50 nucleus carbon atoms which may have a substituent or a heteroaryl group with 5 to 50 nucleus atoms which may have a substituent; Ar¹ and Ar² may be the same or different;

R¹ and R² are a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group; R¹ and R² may be the same or different;

r and s are an integer of 0 to 8; and

R¹s or R²s may be the same or different when r or s is 2 or more.

6. The luminescent ink composition for an organic electroluminescent device according to any one of 1 to 5 which contains 0.5 wt % or more of the anthracene derivative.

7. The luminescent ink composition for an organic electroluminescent device according to any one of 1 to 6 wherein the condensed aromatic ring compound substituted with an arylamino group is a compound represented by the following formula (6): 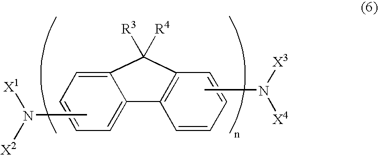
wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; X¹ and X², and X³ and X⁴ may be bonded together to form a ring;

R³ and R⁴ are a group selected from the group consisting of hydrogen, substituted or unsubstituted alkyl, aralkyl and aryl; R³ and R⁴ may be the same or different; R³s or R⁴s bonding different fluorenylene rings may be the same or different; and

n is an integer of 1 to 20.

8. The luminescent ink composition for an organic electroluminescent device according to any one of 1 to 6 wherein the condensed aromatic ring compound substituted with an arylamino group is a compound represented by the following formula (7): 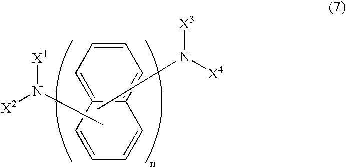
wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; X¹ and X², and X³ and X⁴ may be bonded together to form a ring; and

n is an integer of 1 to 20.

9. The luminescent ink composition for an organic electroluminescent device according to any one of 1 to 6 wherein the condensed aromatic ring compound substituted with an arylamino group is a compound represented by the following formula (8): 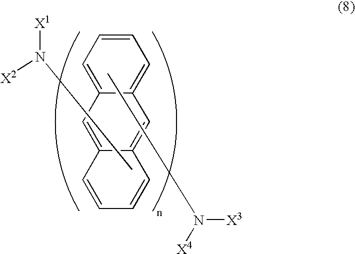
wherein X¹ to X⁴ are a group selected from the group consisting of substituted or unsubstituted alkyl group, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl group having a substituted or unsubstituted arylene group or linking group formed of a divalent heterocyclic group, and carbonyl; X¹ to X⁴ may be the same or different; X¹ and X², and X³ and X⁴ may be bonded together to form a ring; and

n is an integer of 1 to 20.

10. The luminescent ink composition for an organic electroluminescent device according to any one of 1 to 6 wherein the condensed aromatic ring compound substituted with an arylamino group is a compound represented by the following formula (9): 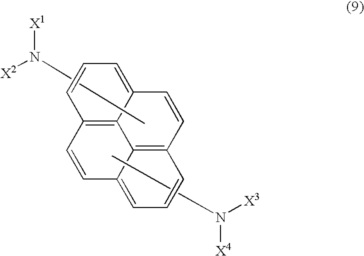
wherein X¹ to X⁴ are a group selected from the group consisting of substituted or unsubstituted alkyl, aralkyl, aryl and heterocycle, substituted or unsubstituted alkenyl having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; and X¹ and X², and X³ and X⁴ may be bonded together to form a ring.
11. The luminescent ink composition for an organic electroluminescent device according to any one of 1 to 6 wherein the condensed aromatic ring compound substituted with an arylamino group is a compound represented by the following formula (10): 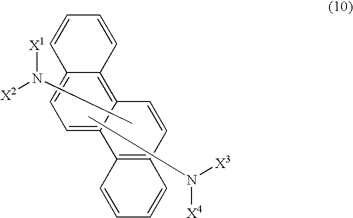
   wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl group having a substituted or unsubstituted arylene group or linking group formed of a divalent heterocyclic group, and carbonyl; X¹ to X⁴ may be the same or different; and X¹ and X², and X³ and X⁴ may be bonded together to form a ring.

12. An organic electroluminescent device comprising an organic thin film produced by using the luminescent ink composition for an organic electroluminescent device of any one of 1 to 11.

According to the invention, a luminescent ink composition for an organic EL device which can form a thin film readily by a wet process can be provided since the content of a luminescent low-molecular material can be increased.

### BRIEF DESCRIPTION OF DRAWING

FIG. 1 is a cross-sectional view showing an embodiment of an organic EL device according to the invention.

### BEST MODE FOR CARRYING OUT THE INVENTION

The luminescent ink composition for an organic EL device of the invention is described below in detail.

The luminescent ink composition for an organic EL device of the invention comprises the following components.

(A) an anthracene derivative represented by the following formula (1);

(B) a condensed aromatic ring compound substituted with an arylamino group and/or a styryl derivative substituted with an arylamino group; and

(C) an organic solvent 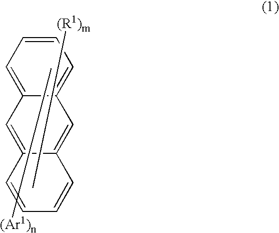
wherein Ar¹ is an aryl group with 6 to 50 nucleus carbon atoms which may have a substituent or a heteroaryl group with 5 to 50 nucleus atoms which may have a substituent;

R¹ is a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group;

n and m are an integer; n+m is 10 or less; and

Ar¹s or R¹s may be the same or different when n or m is 2 or more.

In this composition, the component (A) is a luminescent low-molecular material, and, for example, forms a host of an emitting material. The component (B) mainly functions as a dopant which adjusts color development. Each component is explained below.

(A) Anthracene Derivative Represented by Formula (1)

In the above formula (1), examples of the aryl group having 6 to 50 nucleus carbon atoms include phenyl, 2-biphenyl, 3-biphenyl, 4-biphenyl, terphenyl, 3,5-diphenylphenyl, 3,5-di(1-naphthyl)phenyl, 3,5-di(2-napthylphenyl), 3,4-diphenylphenyl, pentaphenylphenyl, 4-(2,2-diphenylvinyl)phenyl, 4-(1,2,2-triphenylvinyl)phenyl, fluorenyl, 1-naphthyl, 2-naphthyl, 4-(1-naphthyl)phenyl, 4-(2-naphthyl)phenyl, 3-(1-naphthyl)phenyl, 3-(2-naphthyl)phenyl, 9-anthryl, 2-anthryl, 9-phenanthryl, 1-pyrenyl, crycenyl, naphthacenyl, and cholonyl.

Examples of a heteroaryl group having 5 to 50 nucleus atoms include 1-pyrrolyl, 2-pyrrolyl, 3-pyrrolyl, pyrazinyl, pyrimidyl, pyridazyl, 2-pyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthrolin-2-yl, 1,7-phenanthrolin-3-yl, 1,7-phenanthrolin-4-yl, 1,7-phenanthrolin-5-yl, 1,7-phenanthrolin-6-yl, 1,7-phenanthrolin-8-yl, 1,7-phenanthrolin-9-yl, 1,7-phenanthrolin-10-yl, 1,8-phenanthrolin-2-yl, 1,8-phenanthrolin-3-yl, 1,8-phenanthrolin-4-yl, 1,8-phenanthrolin-5-yl, 1,8-phenanthrolin-6-yl, 1,8-phenanthrolin-7-yl, 1,8-phenanthrolin-9-yl, 1,8-phenanthrolin-10-yl, 1,9-phenanthrolin-2-yl, 1,9-phenanthrolin-3-yl, 1,9-phenanthrolin-4-yl, 1,9-phenanthrolin-5-yl, 1,9-phenanthrolin-6-yl, 1,9-phenanthrolin-7-yl, 1,9-phenanthrolin-8-yl, 1,9-phenanthrolin-10-yl, 1,10-phenanthrolin-2-yl, 1,10-phenanthrolin-3-yl, 1,10-phenanthrolin-4-yl, 1,10-phenanthrolin-5-yl, 2,9-phenanthrolin-1-yl, 2,9-phenanthrolin-3-yl, 2,9-phenanthrolin-4-yl, 2,9-phenanthrolin-5-yl, 2,9-phenanthrolin-6-yl, 2,9-phenanthrolin-7-yl, 2,9-phenanthrolin-8-yl, 2,9-phenanthrolin-10-yl, 2,8-phenanthrolin-1-yl, 2,8-phenanthrolin-3-yl, 2,8-phenanthrolin-4-yl, 2,8-phenanthrolin-5-yl, 2,8-phenanthrolin-6-yl, 2,8-phenanthrolin-7-yl, 2,8-phenanthrolin-9-yl, 2,8-phenanthrolin-10-yl, 2,7-phenanthrolin-1-yl, 2,7-phenanthrolin-3-yl, 2,7-phenanthrolin-4-yl, 2,7-phenanthrolin-5-yl, 2,7-phenanthrolin-6-yl, 2,7-phenanthrolin-8-yl, 2,7-phenanthrolin-9-yl, 2,7-phenanthrolin-10-yl, 1-phenazinyl, 2-phenazinyl, 1-phenothiadinyl, 2-phenothiadinyl, 3-phenothiadinyl, 4-phenothiadinyl, 10-phenothiadinyl, 1-phenoxadinyl, 2-phenoxadinyl, 3-phenoxadinyl, 4-phenoxadinyl, 10-phenoxadinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrol-1-yl, 2-methylpyrrol-3-yl, 2-methylpyrrol-4-yl, 2-methylpyrrol-5-yl, 3-methylpyrrol-1-yl, 3-methylpyrrol-2-yl, 3-methylpyrrol-4-yl, 3-methylpyrrol-5-yl, 2-t-butyl-pyrrol-4-yl, 3-(2-phenylpropyl)pyrrol-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, and 4-t-butyl-3-indolyl.

Examples of the substituted or unsubstituted alkyl group having 1 to 50 carbon atoms represented by R¹ include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, 1,2,3-trinitropropyl, cyclopropyl, cyclobutyl, cyclopentyl, cyclohexyl, 4-methylcyclohexyl, 1-adamantyl, 2-adamantyl, 1-norbornyl, and 2-norbornyl.

The substituted or unsubstituted alkoxy group having 1 to 50 carbon atoms is a group represented by —OY¹. Examples of Y¹ include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, and 1,2,3-trinitropropyl.

Examples of the substituted or unsubstituted aralkyl group include benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl, and 1-chloro-2-phenylisopropyl.

The substituted or unsubstituted aryloxy group is represented by —OY′. Examples of Y′ include phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, 2-pyrrolyl, 3-pyrrolyl, pyrazinyl, 2-pyridinyl, 3-pyridinyl, 4-pyridinyl, 2-indolyl, 3-indolyl, 4-indolyl, 5-indolyl, 6-indolyl, 7-indolyl, 1-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthrolin-2-yl, 1,7-phenanthrolin-3-yl, 1,7-phenanthrolin-4-yl, 1,7-phenanthrolin-5-yl, 1,7-phenanthrolin-6-yl, 1,7-phenanthrolin-8-yl, 1,7-phenanthrolin-9-yl, 1,7-phenanthrolin-10-yl, 1,8-phenanthrolin-2-yl, 1,8-phenanthrolin-3-yl, 1,8-phenanthrolin-4-yl, 1,8-phenanthrolin-5-yl, 1,8-phenanthrolin-6-yl, 1,8-phenanthrolin-7-yl, 1,8-phenanthrolin-9-yl, 1,8-phenanthrolin-10-yl, 1,9-phenanthrolin-2-yl, 1,9-phenanthrolin-3-yl, 1,9-phenanthrolin-4-yl, 1,9-phenanthrolin-5-yl, 1,9-phenanthrolin-6-yl, 1,9-phenanthrolin-7-yl, 1,9-phenanthrolin-8-yl, 1,9-phenanthrolin-10-yl, 1,10-phenanthrolin-2-yl, 1,10-phenanthrolin-3-yl, 1,10-phenanthrolin-4-yl, 1,10-phenanthrolin-5-yl, 2,9-phenanthrolin-1-yl, 2,9-phenanthrolin-3-yl, 2,9-phenanthrolin-4-yl, 2,9-phenanthrolin-5-yl, 2,9-phenanthrolin-6-yl, 2,9-phenanthrolin-7-yl, 2,9-phenanthrolin-8-yl, 2,9-phenanthrolin-10-yl, 2,8-phenanthrolin-1-yl, 2,8-phenanthrolin-3-yl, 2,8-phenanthrolin-4-yl, 2,8-phenanthrolin-5-yl, 2,8-phenanthrolin-6-yl, 2,8-phenanthrolin-7-yl, 2,8-phenanthrolin-9-yl, 2,8-phenanthrolin-10-yl, 2,7-phenanthrolin-1-yl, 2,7-phenanthrolin-3-yl, 2,7-phenanthrolin-4-yl, 2,7-phenanthrolin-5-yl, 2,7-phenanthrolin-6-yl, 2,7-phenanthrolin-8-yl, 2,7-phenanthrolin-9-yl, 2,7-phenanthrolin-10-yl, 1-phenazinyl, 2-phenazinyl, 1-phenothiadinyl, 2-phenothiadinyl, 3-phenothiadinyl, 4-phenothiadinyl, 1-phenoxadinyl, 2-phenoxadinyl, 3-phenoxadinyl, 4-phenoxadinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrol-1-yl, 2-methylpyrrol-3-yl, 2-methylpyrrol-4-yl, 2-methylpyrrol-5-yl, 3-methylpyrrol-1-yl, 3-methylpyrrol-2-yl, 3-methylpyrrol-4-yl, 3-methylpyrrol-5-yl, 2-t-butylpyrrol-4-yl, 3-(2-phenylpropyl)pyrrol-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, and 4-t-butyl-3-indolyl.

The substituted or unsubstituted arylthio group is represented by —SY″. Examples of Y″ include phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-l-naphthyl, 4-methyl-1-anthryl, 4′-methylbiphenylyl, 4″-t-butyl-p-terphenyl-4-yl, 2-pyrrolyl, 3-pyrrolyl, pyrazinyl, 2-pyridinyl, 3-pyridinyl, 4-pyridinyl, 2-indolyl, 3-indolyl, 4-indolyl, 5-indolyl, 6-indolyl, 7-indolyl, 1-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 1-phenanthridinyl, 2-phenanthridinyl, 3-phenanthridinyl, 4-phenanthridinyl, 6-phenanthridinyl, 7-phenanthridinyl, 8-phenanthridinyl, 9-phenanthridinyl, 10-phenanthridinyl, 1-acridinyl, 2-acridinyl, 3-acridinyl, 4-acridinyl, 9-acridinyl, 1,7-phenanthrolin-2-yl, 1,7-phenanthrolin-3-yl, 1,7-phenanthrolin-4-yl, 1,7-phenanthrolin-5-yl, 1,7-phenanthrolin-6-yl, 1,7-phenanthrolin-8-yl, 1,7-phenanthrolin-9-yl, 1,7-phenanthrolin-10-yl, 1,8-phenanthrolin-2-yl, 1,8-phenanthrolin-3-yl, 1,8-phenanthrolin-4-yl, 1,8-phenanthrolin-5-yl, 1,8-phenanthrolin-6-yl, 1,8-phenanthrolin-7-yl, 1,8-phenanthrolin-9-yl, 1,8-phenanthrolin-10-yl, 1,9-phenanthrolin-2-yl, 1,9-phenanthrolin-3-yl, 1,9-phenanthrolin-4-yl, 1,9-phenanthrolin-5-yl, 1,9-phenanthrolin-6-yl, 1,9-phenanthrolin-7-yl, 1,9-phenanthrolin-8-yl, 1,9-phenanthrolin-10-yl, 1,10-phenanthrolin-2-yl, 1,10-phenanthrolin-3-yl, 1,10-phenanthrolin-4-yl, 1,10-phenanthrolin-5-yl, 2,9-phenanthrolin-1-yl, 2,9-phenanthrolin-3-yl, 2,9-phenanthrolin-4-yl, 2,9-phenanthrolin-5-yl, 2,9-phenanthrolin-6-yl, 2,9-phenanthrolin-7-yl, 2,9-phenanthrolin-8-yl, 2,9-phenanthrolin-10-yl, 2,8-phenanthrolin-1-yl, 2,8-phenanthrolin-3-yl, 2,8-phenanthrolin-4-yl, 2,8-phenanthrolin-5-yl, 2,8-phenanthrolin-6-yl, 2,8-phenanthrolin-7-yl, 2,8-phenanthrolin-9-yl, 2,8-phenanthrolin-10-yl, 2,7-phenanthrolin-1-yl, 2,7-phenanthrolin-3-yl, 2,7-phenanthrolin-4-yl, 2,7-phenanthrolin-5-yl, 2,7-phenanthrolin-6-yl, 2,7-phenanthrolin-8-yl, 2,7-phenanthrolin-9-yl, 2,7-phenanthrolin-10-yl, 1-phenazinyl, 2-phenazinyl, 1-phenothiadinyl, 2-phenothiadinyl, 3-phenothiadinyl, 4-phenothiadinyl, 1-phenoxadinyl, 2-phenoxadinyl, 3-phenoxadinyl, 4-phenoxadinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrol-1-yl, 2-methylpyrrol-3-yl, 2-methylpyrrol-4-yl, 2-methylpyrrol-5-yl, 3-methylpyrrol-1-yl, 3-methylpyrrol-2-yl, 3-methylpyrrol-4-yl, 3-methylpyrrol-5-yl, 2-t-butyl-pyrrol-4-yl, 3-(2-phenylpropyl)pyrrol-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, and 4-t-butyl-3-indolyl.

The substituted or unsubstituted alkoxycarboxyl group is represented by —COOZ. Examples of Z include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, and 1,2,3-trinitropropyl.

n and m are an integer, and n+m is 10 or less.

Preferred anthracene derivatives represented by the above formula (1) are those represented by the following formula (2) or (4). Particularly preferred anthracene derivatives are those represented by the formula (3) or (5). 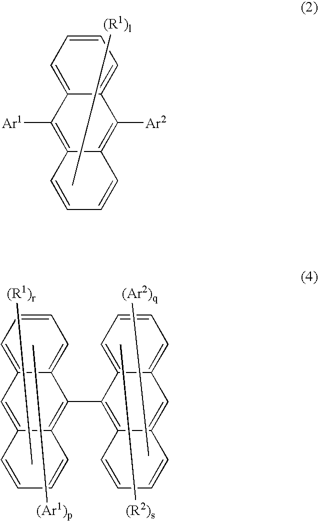
wherein Ar¹ and R¹ have the same meanings as those in the above formula (1). Examples of Ar² and R² are the same as those of Ar¹ and R¹.

In the formula (2), Ar¹ and Ar² are different. 1 is an integer of 0 to 8, and R¹s or R²s may be the same or different when 1 is 2 or more.

In the formula (4), Ar¹ and Ar² may be the same or different. p and q are an integer of 1 to 8. r and s are an integer of 0 to 8. Ar¹s, Ar²s, R¹s or R²s may be the same or different when p, q, r or s is 2 or more. 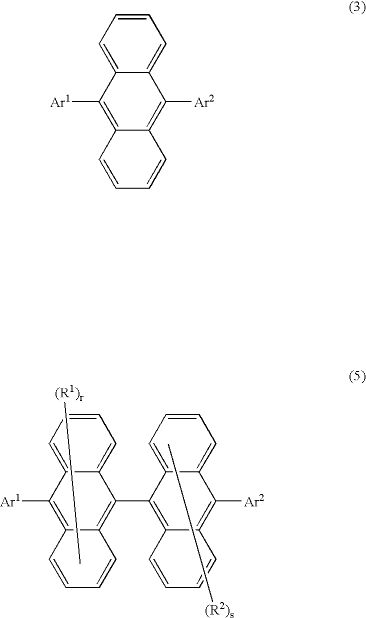
wherein Ar¹ and R¹ have the same meanings as those in the above formula (1). Examples of Ar² and R² are the same as those of Ar¹ and R¹.

In the formula (3), Ar¹ and Ar² are different.

In the formula (5), Ar¹ and Ar² may be the same or different. r and s are an integer of 0 to 8. R¹ s or R²s may be the same or different when r or s is 2 or more.

Preferred examples of the anthracene compounds are shown below. 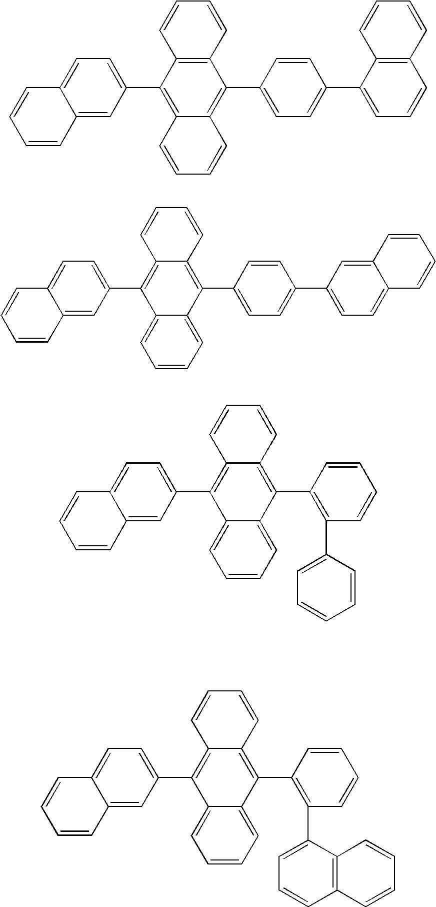 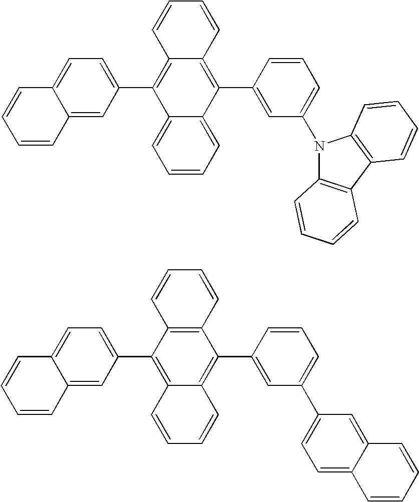 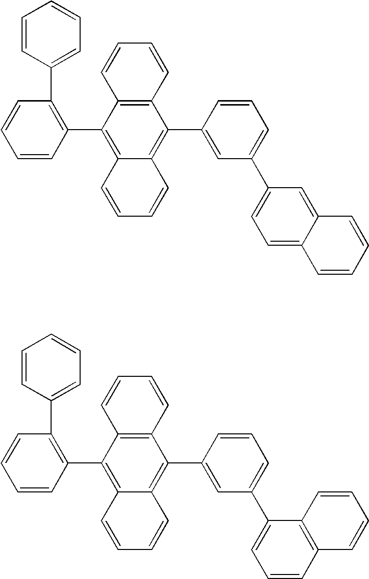 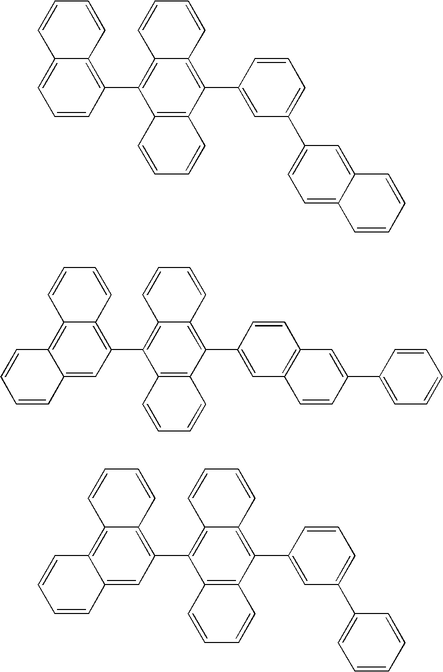 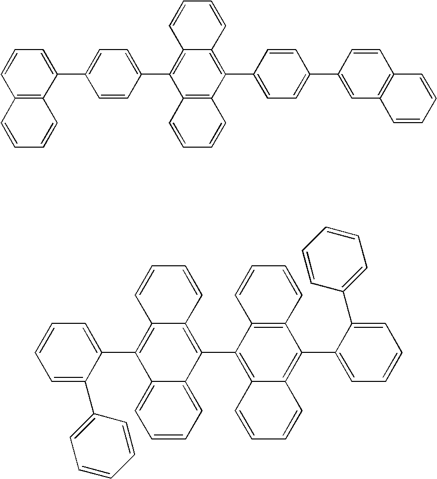 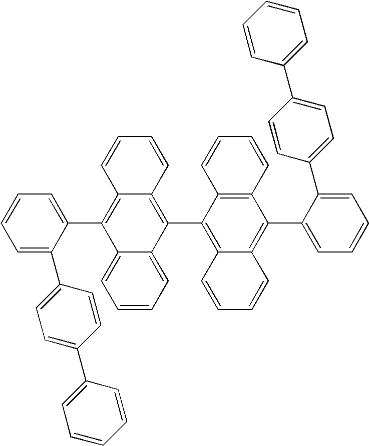 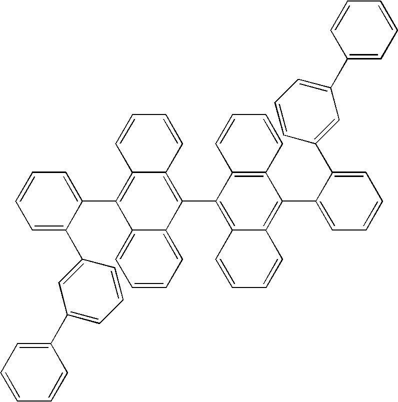 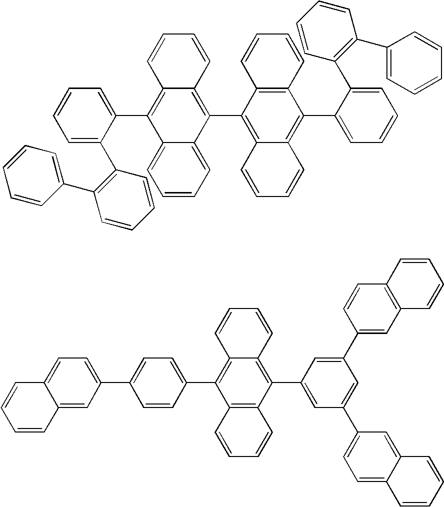 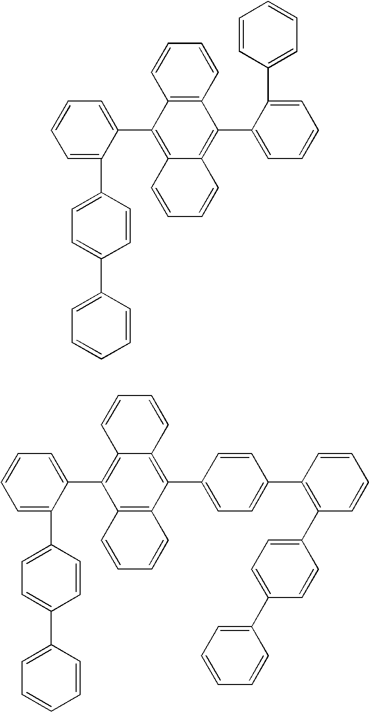 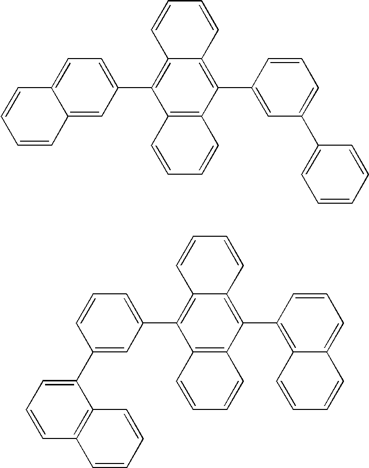 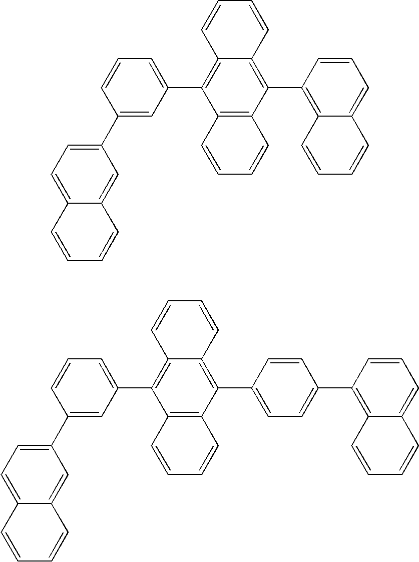 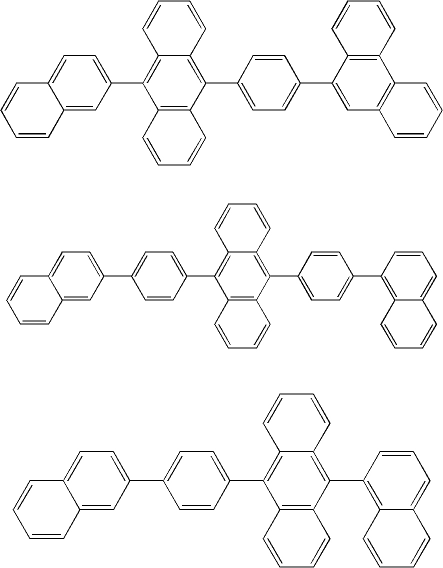 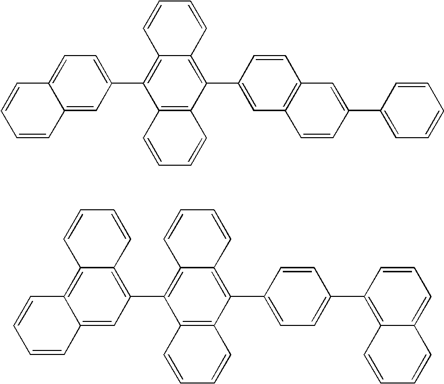 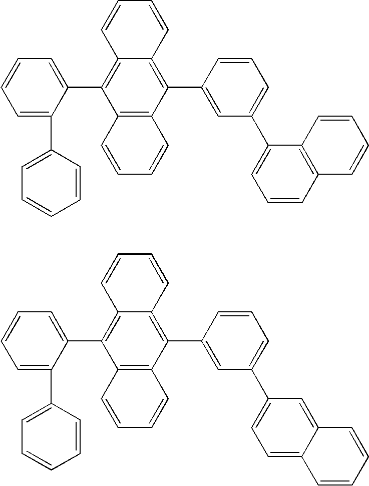 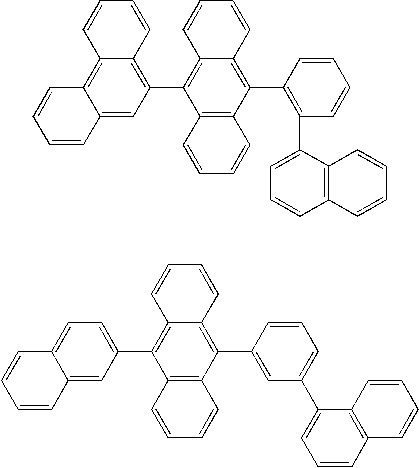 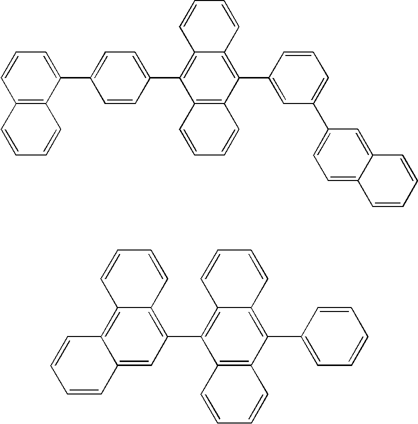 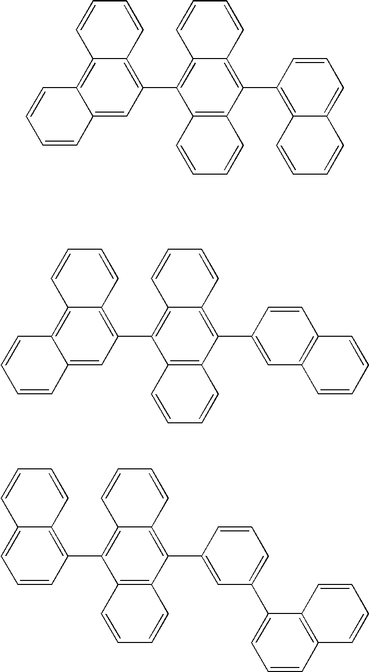
(B) Condensed Aromatic Ring Compound Substituted with an Arylamino Group and/or a Styryl Derivative Substituted with an Arylamino Group

Preferred condensed aromatic ring compounds substituted with an arylamino group are represented by the following formulas (6) to (10). 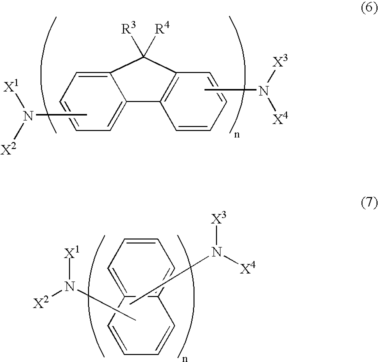 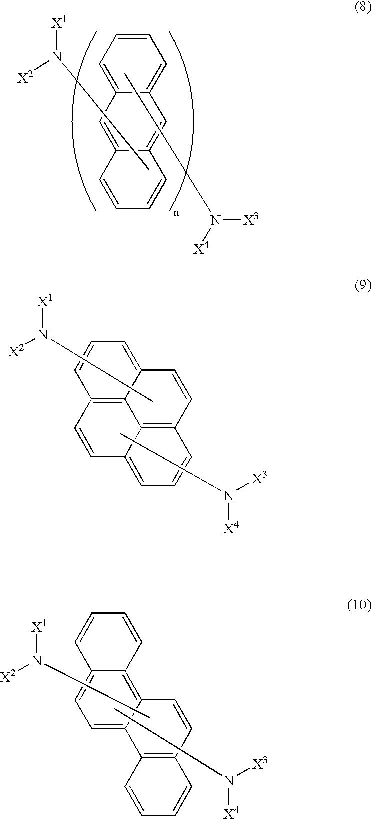
wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; X¹ and X², and X³ and X⁴ may be bonded together to form a ring;

R³ and R⁴ are a group selected from the group consisting of hydrogen, substituted or unsubstituted alkyl, aralkyl and aryl; R³ and R⁴ may be the same or different; R³s or R⁴s bonding different fluorenylene rings may be the same or different; and

n is an integer of 1 to 20.

Preferred condensed aromatic ring compound substituted with an arylamino group that is the component (B) are represented by the following formula (11). 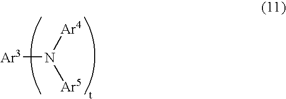
wherein Ar³, Ar⁴ and Ar⁵ are independently a substituted or unsubstituted aryl group having 5 to 40 nucleus carbon atoms; and t is an integer of 1 to 4.

Examples of the aryl group having 5 to 40 nucleus carbon atoms include phenyl, naphthyl, crycenyl, naththacenyl, anthranyl, phenanthryl, pyrenyl, cholonyl, biphenyl, terphenyl, pyrrolyl, furanyl, thiophenyl, benzothiophenyl, oxadiazolyl, diphenylanthranyl, indolyl, carbozolyl, pyridyl, benzoquinolyl, fluoranthenyl, acetonaphtofluoranthenyl, stilbene, and fluorenyl.

Phenyl, naphthyl, crycenyl, anthranyl, pyrenyl, biphenyl, carbazolyl, and fluorenyl are preferable.

Examples of the preferred substituent for the aryl group include an alkyl group having 1 to 6 carbon atoms (ethyl, methyl, i-propyl, n-propyl, s-butyl, t-butyl, pentyl, hexyl, cyclopentyl, cyclohexyl, or the like); an alkoxy group having 1 to 6 carbon atoms (ethoxy, methoxy, i-propoxy, n-propoxy, s-butoxy, t-butoxy, pentoxy, hexyloxy, cyclopentoxy, cyclohexyloxy, or the like); an aryl group having 5 to 40 nucleus atoms; an amino group substituted with an aryl group having 5 to 40 nucleus atoms; an ester group with an aryl group having 5 to 40 nucleus atoms; an ester group with an alkyl group having 1 to 6 carbon atoms; a cyano group; a nitro group; and a halogen atom.

Ethyl, methyl, i-propyl, t-butyl, cyclohexyl, and amino substituted with an aryl group are particularly preferable.

Preferred styryl derivatives substituted with an arylamino group as the component (B) are represented by the following formula (12). 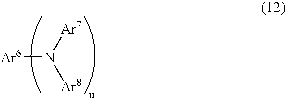
wherein Ar⁶ is a group selected from phenyl, biphenyl, terphenyl, stilbene and distyrylaryl; Ar⁷ and Ar⁸ are independently a hydrogen atom or an aromatic group having 6 to 20 carbon atoms; Ar⁶, Ar⁷ and Ar⁸ may be substituted; u is an integer of 1 to 4; at least one of Ar⁷ and Ar⁸ is substituted with a styryl group, when Ar⁶ is a phenyl, biphenyl or terphenyl group.

Examples of the aromatic group having 6 to 20 carbon atoms include phenyl, naphthyl, anthranyl, phenanthryl, and terphenyl. Phenyl, naphthyl and anthranyl are preferable.

Examples of the substituent for Ar⁶, Ar⁷ and Ar⁸ are the same as those for the formula (11).

The specific structures of the compounds which are preferred as the component (B) are shown below. In the formula, “Me” represents methyl, “Et” represents ethyl, “^{t}Bu” represents t-butyl, “ⁿBu” represents n-butyl, and “Ph” represents phenyl. 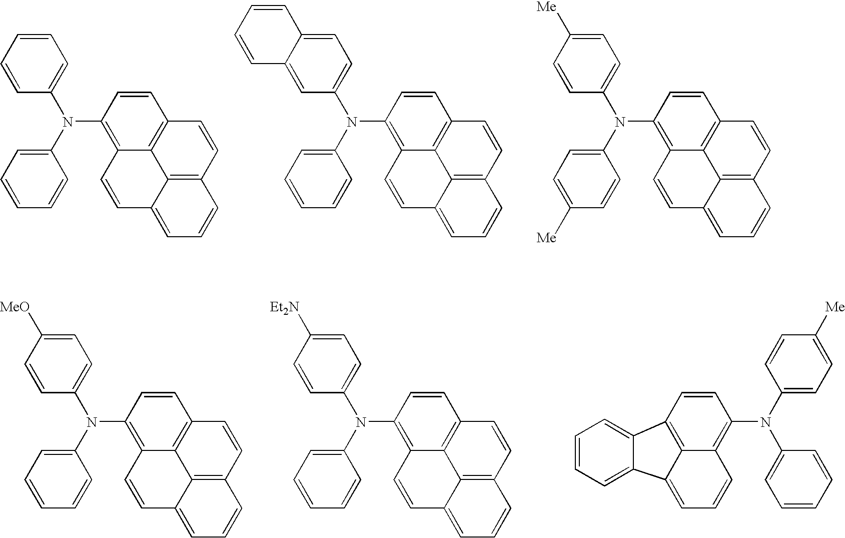 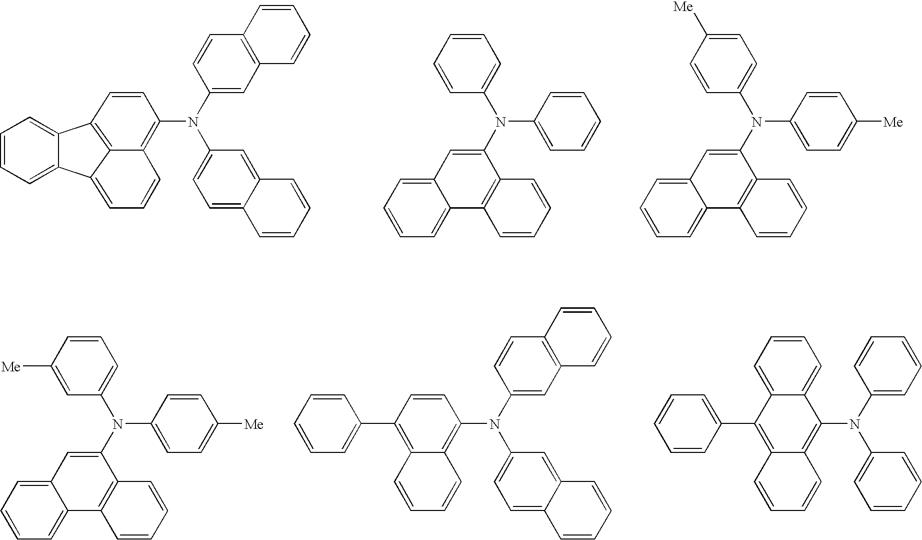 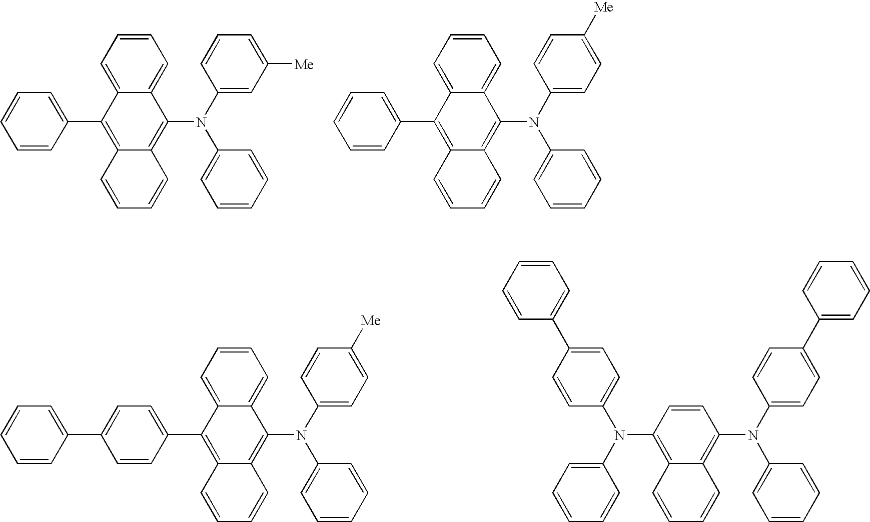 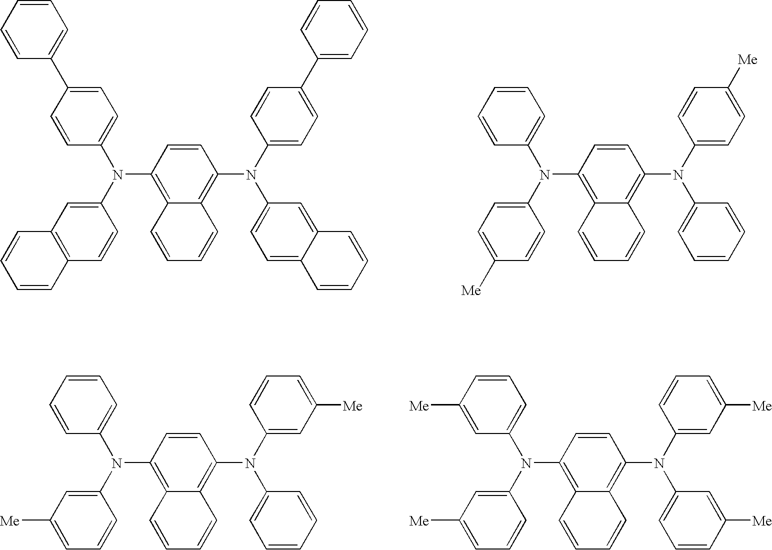 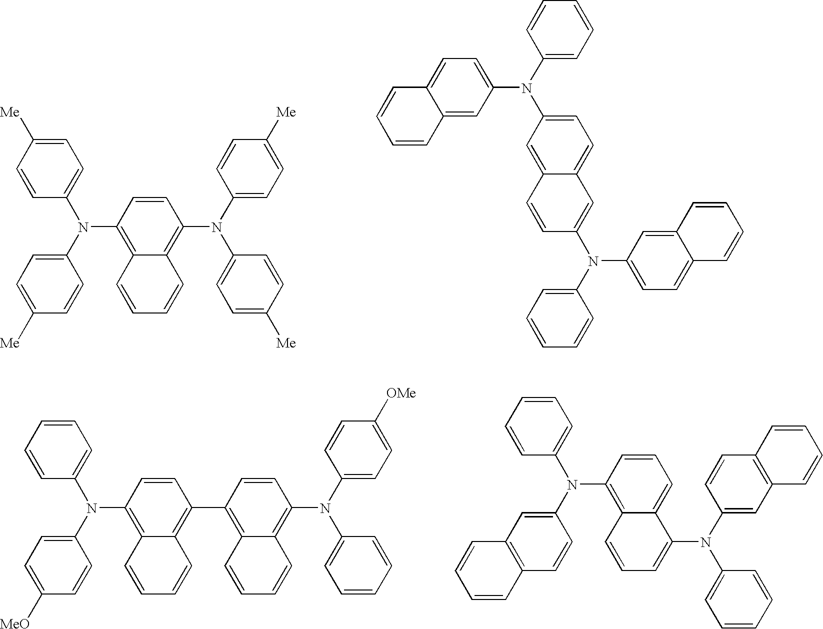 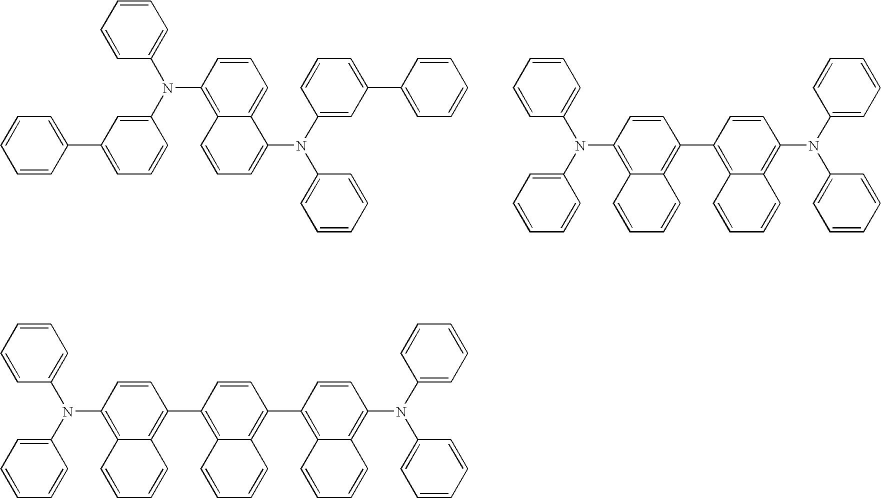 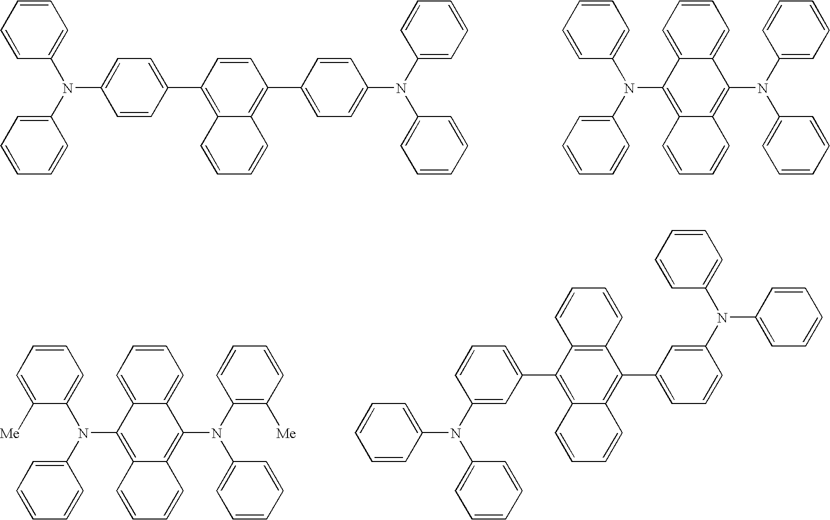 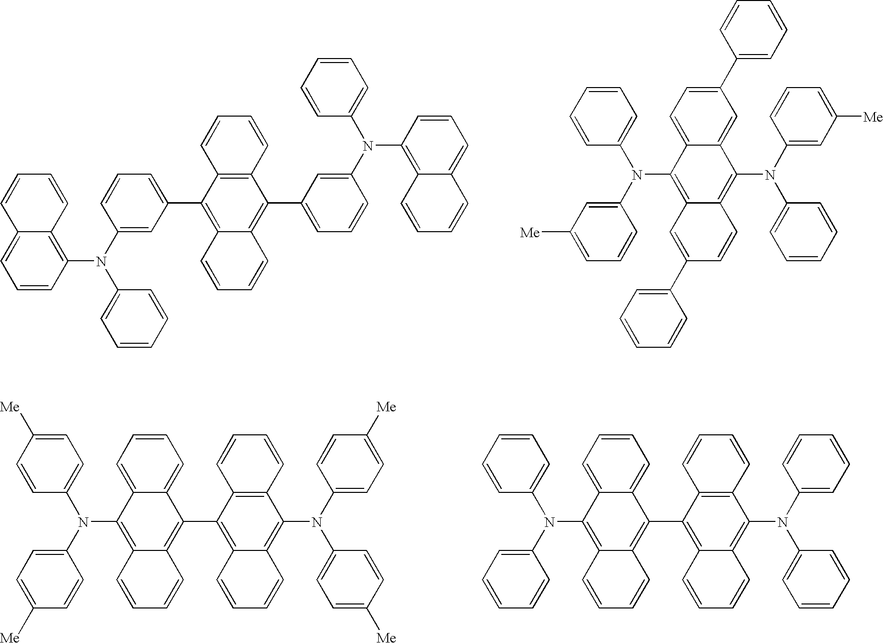 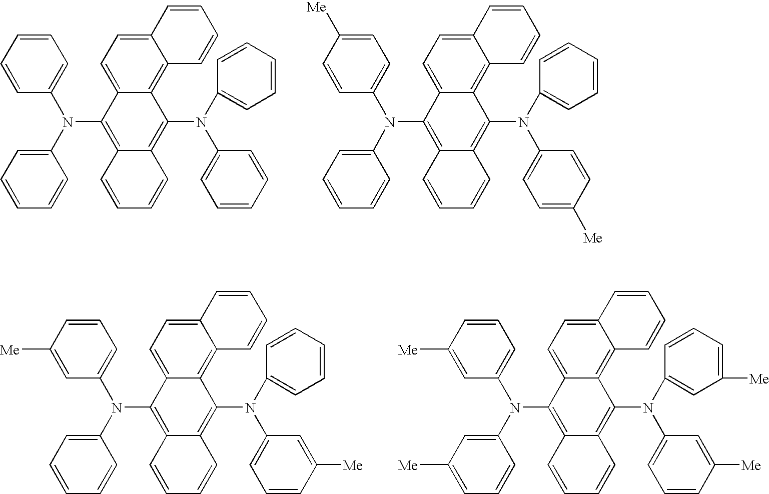 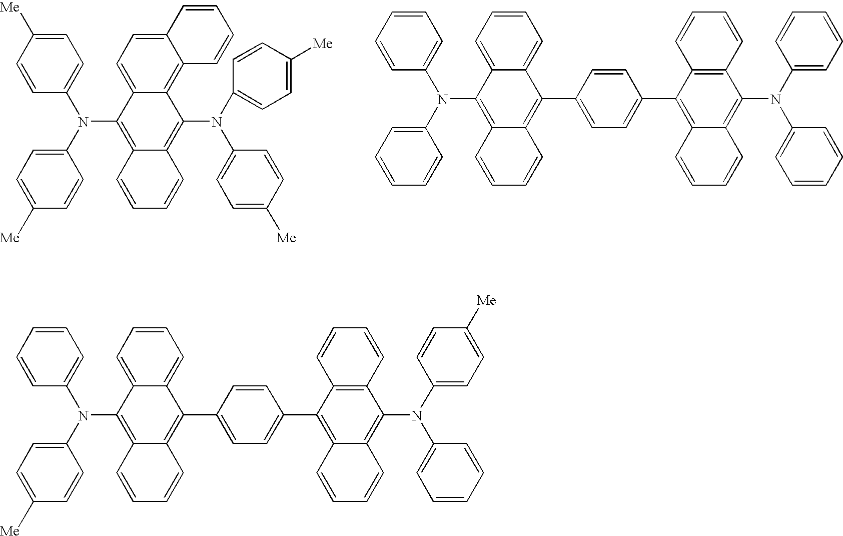 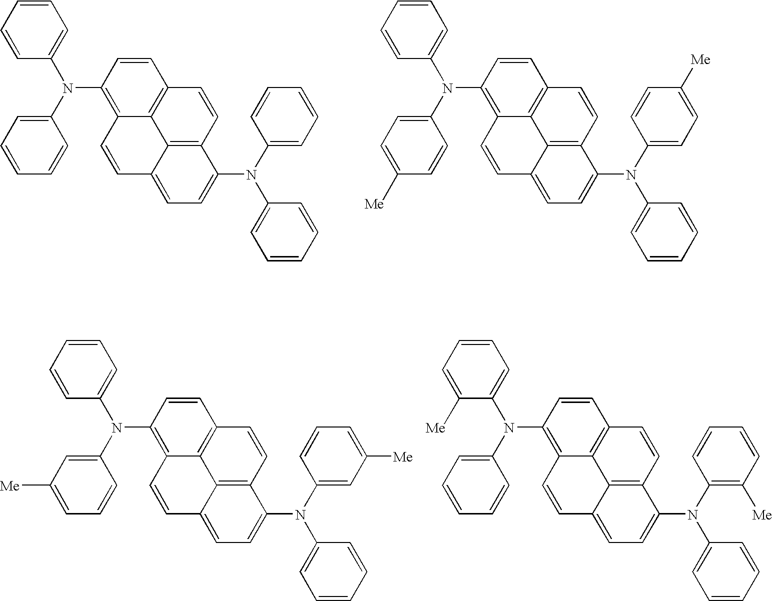 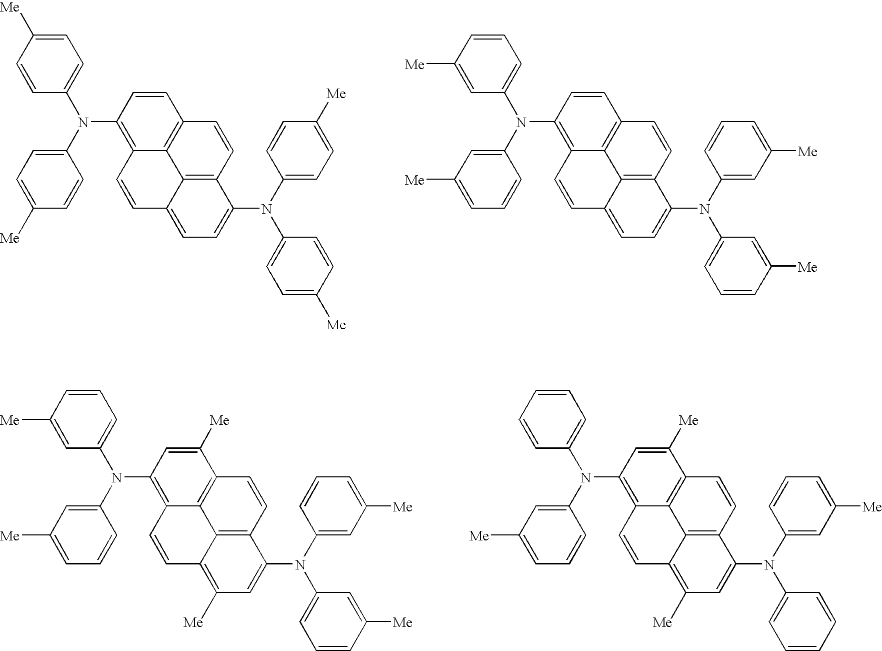 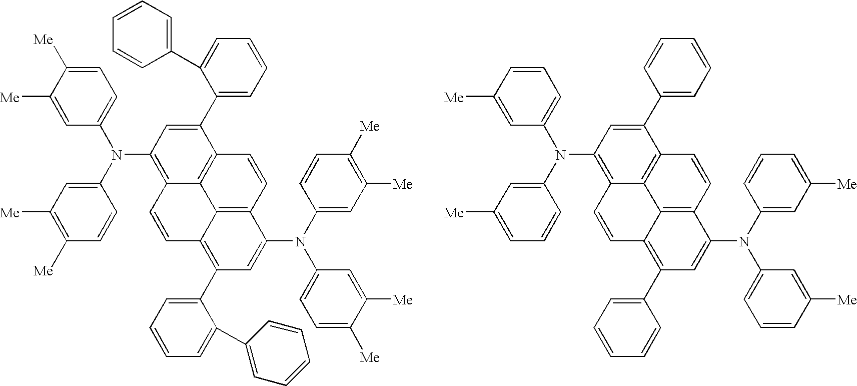 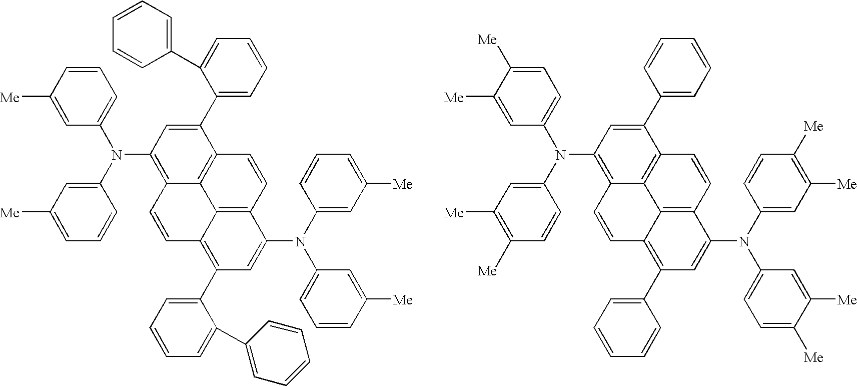 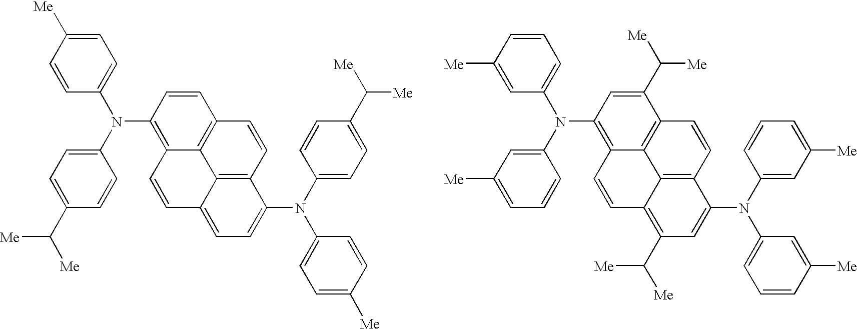 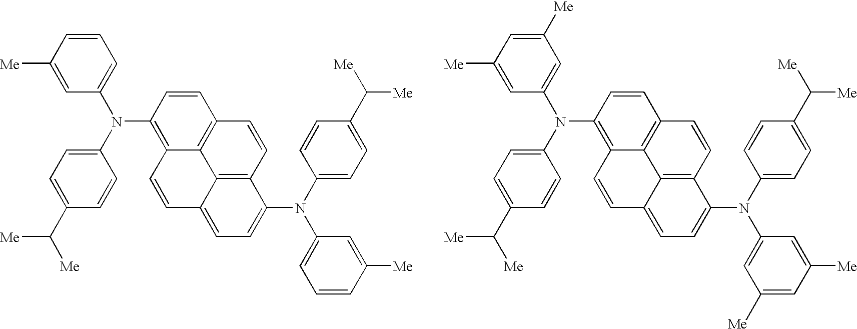 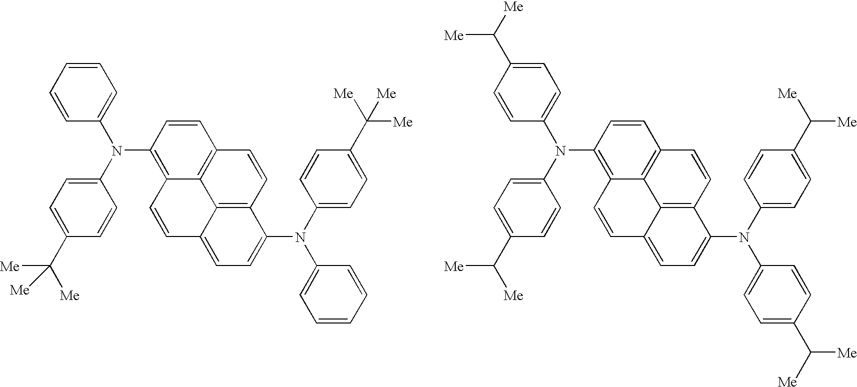 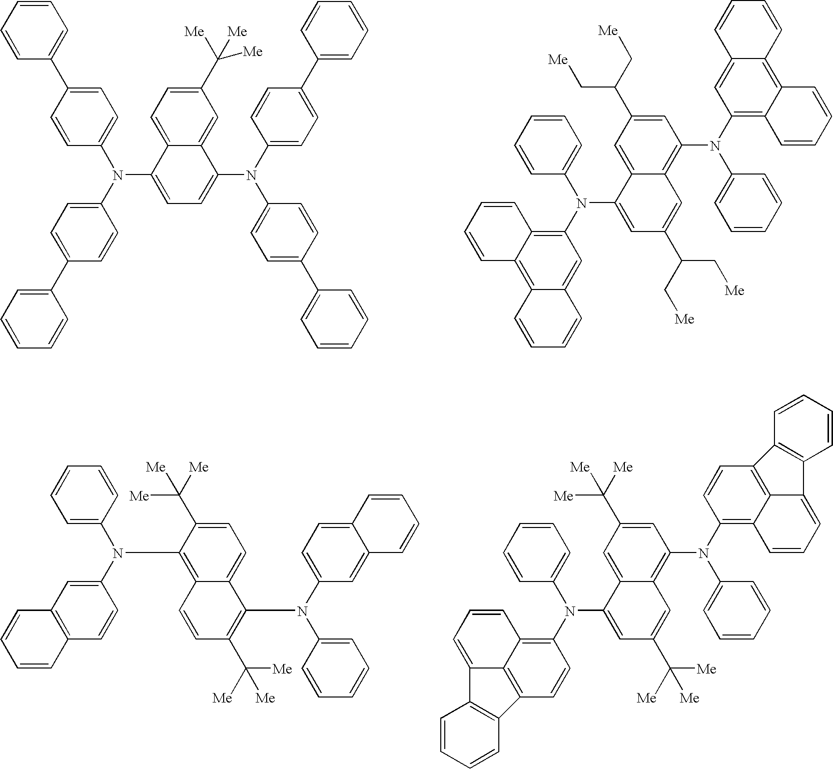 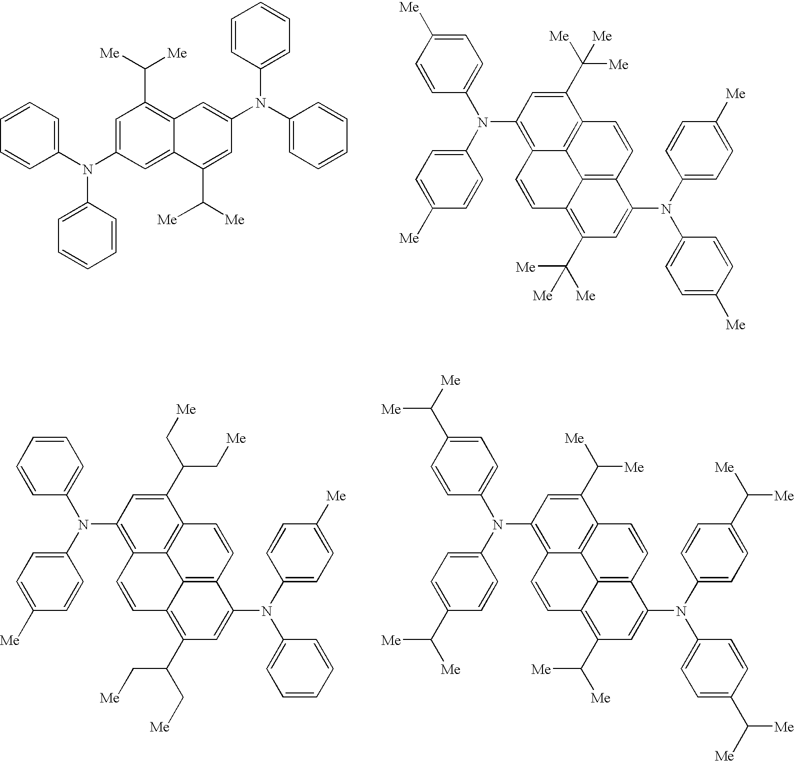 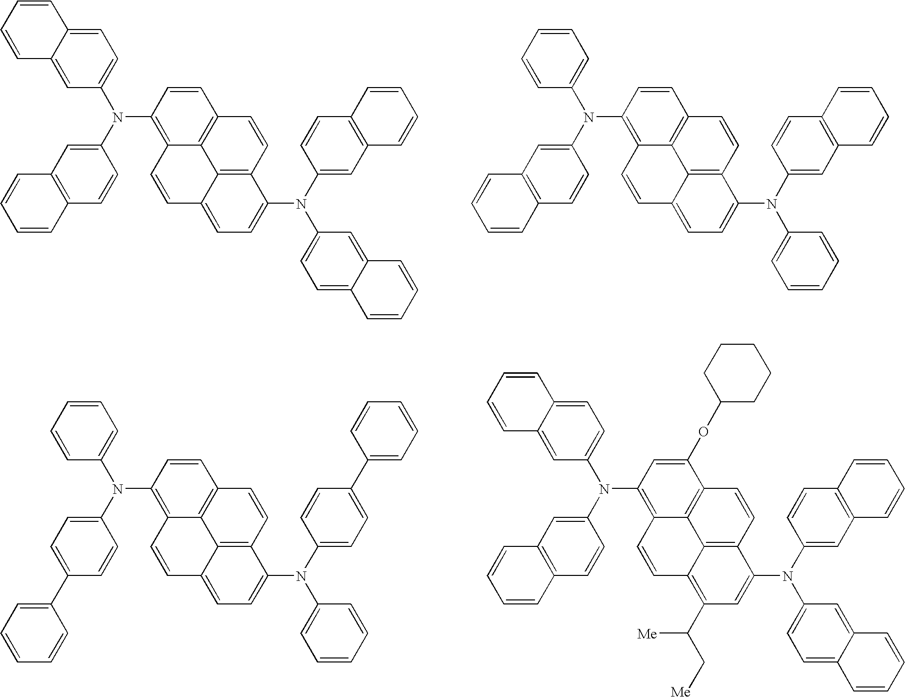 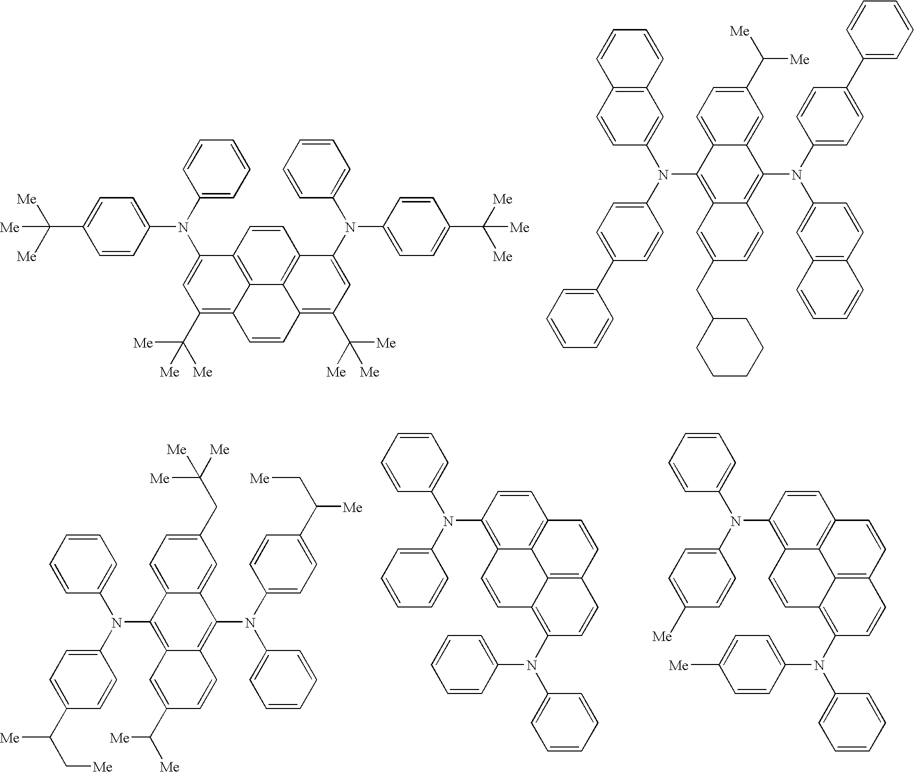 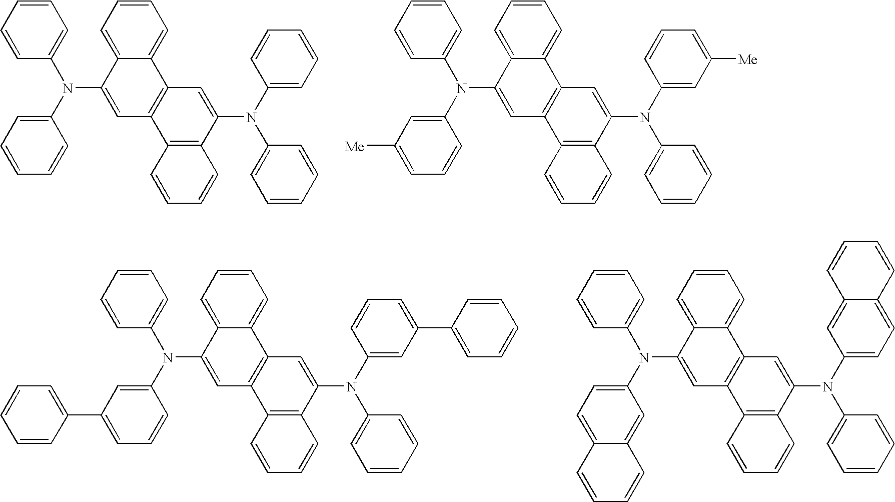 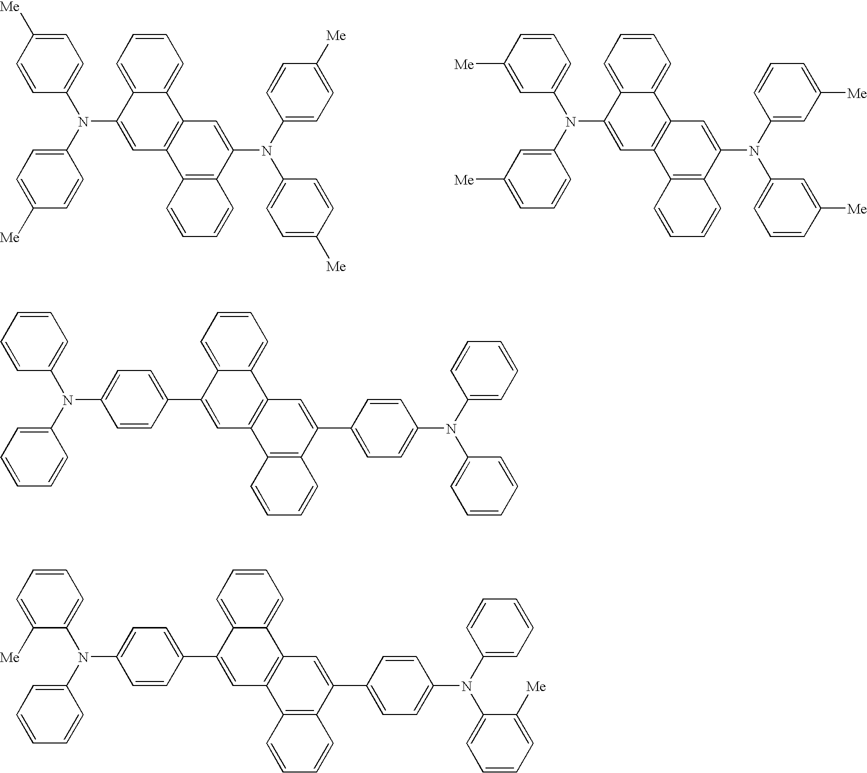 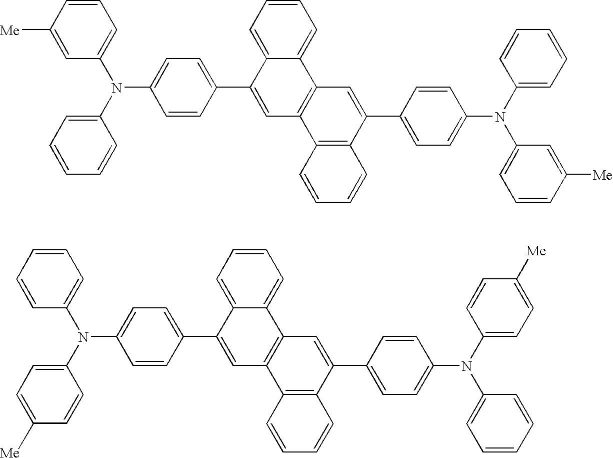 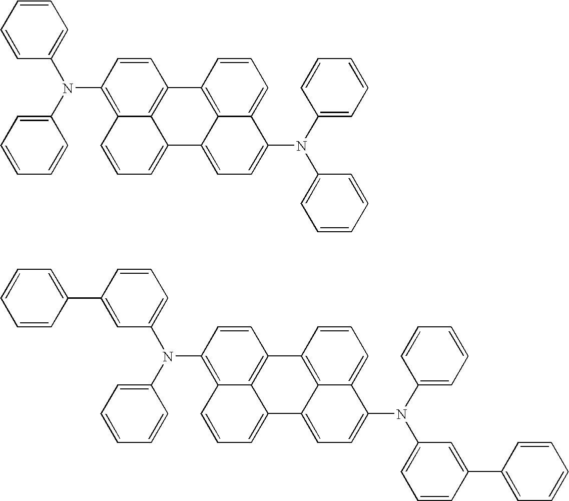 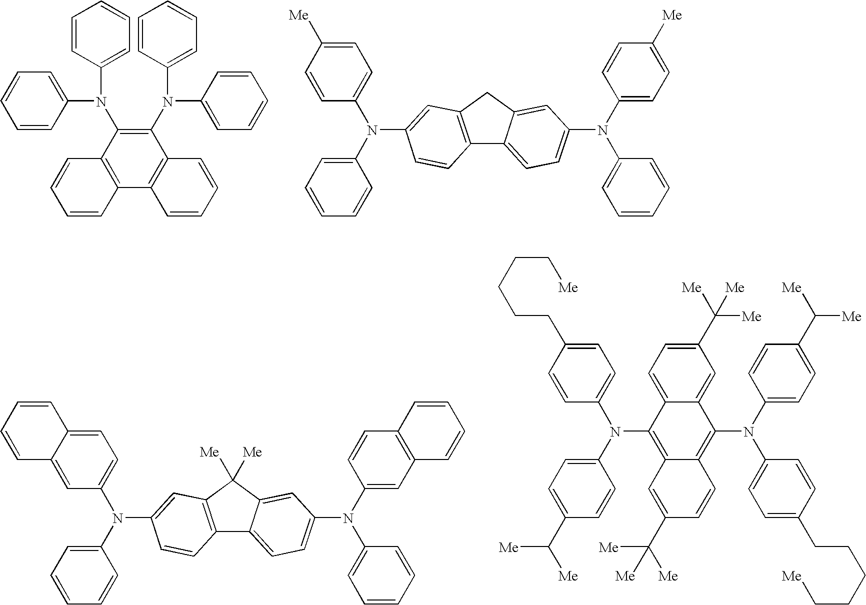 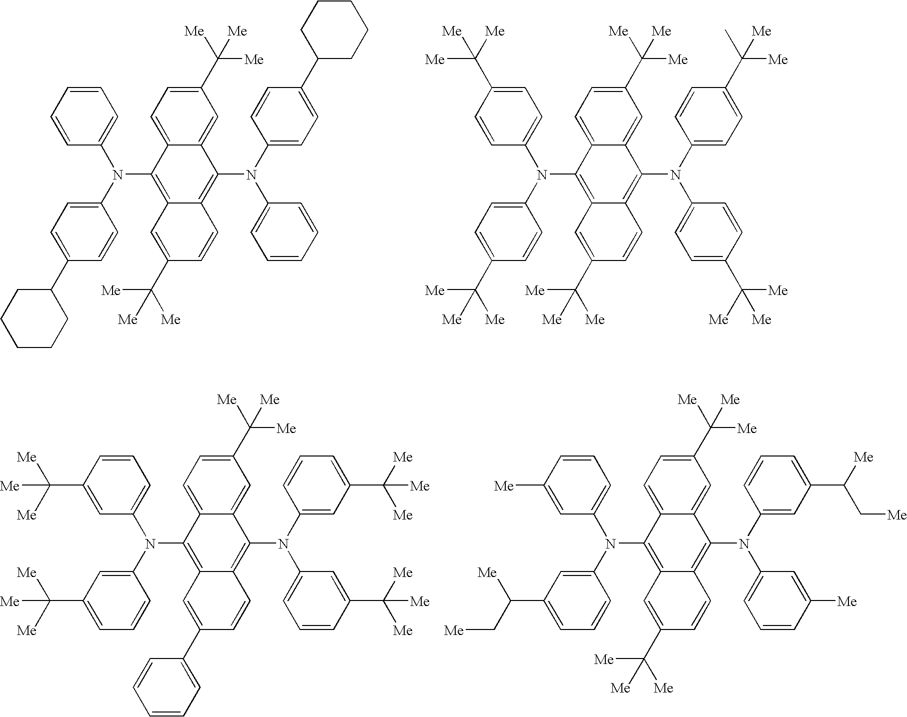 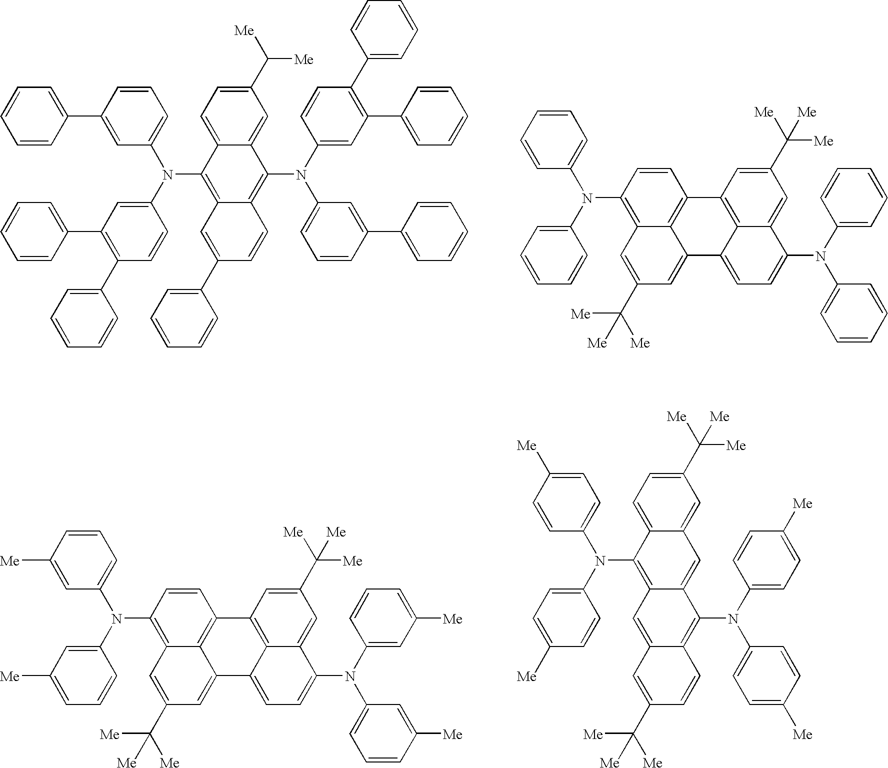 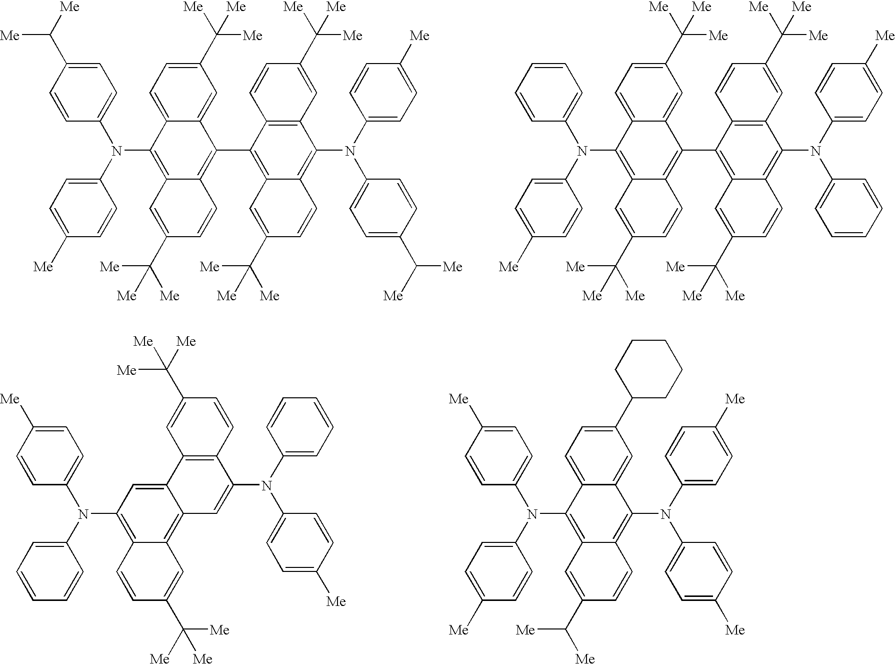 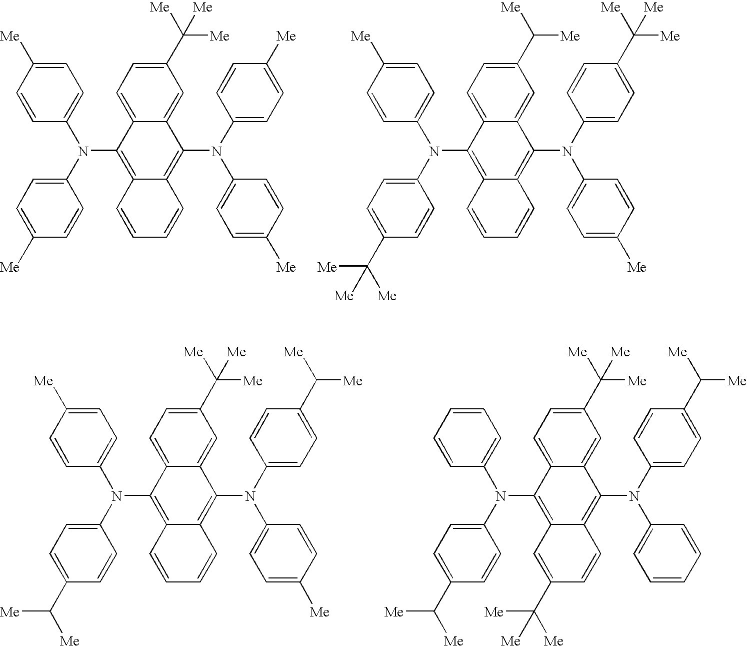 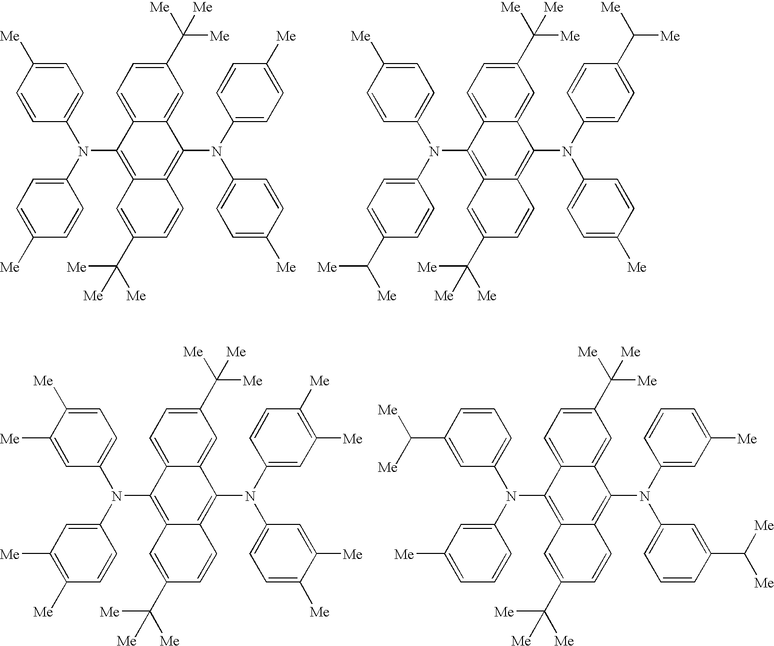 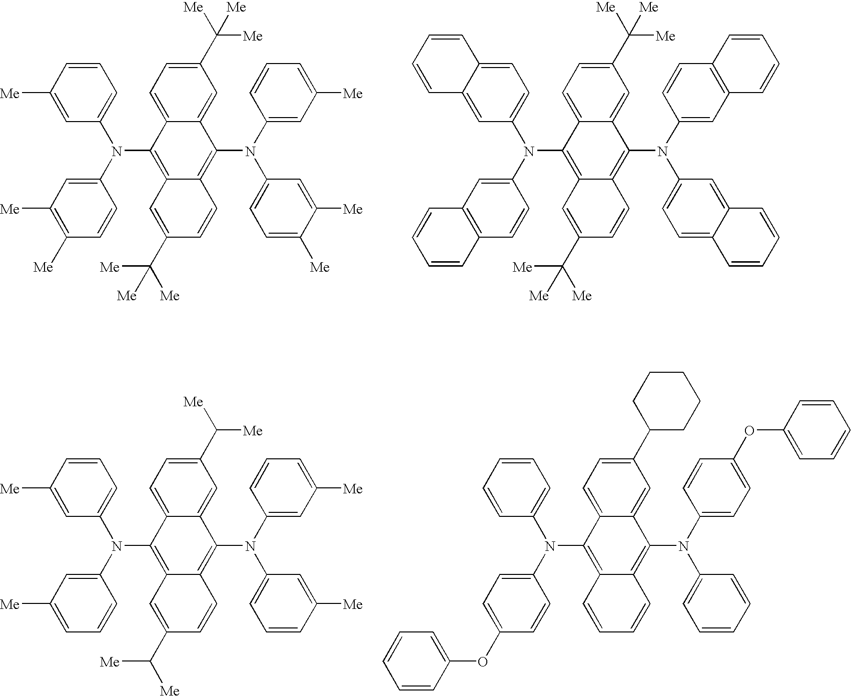 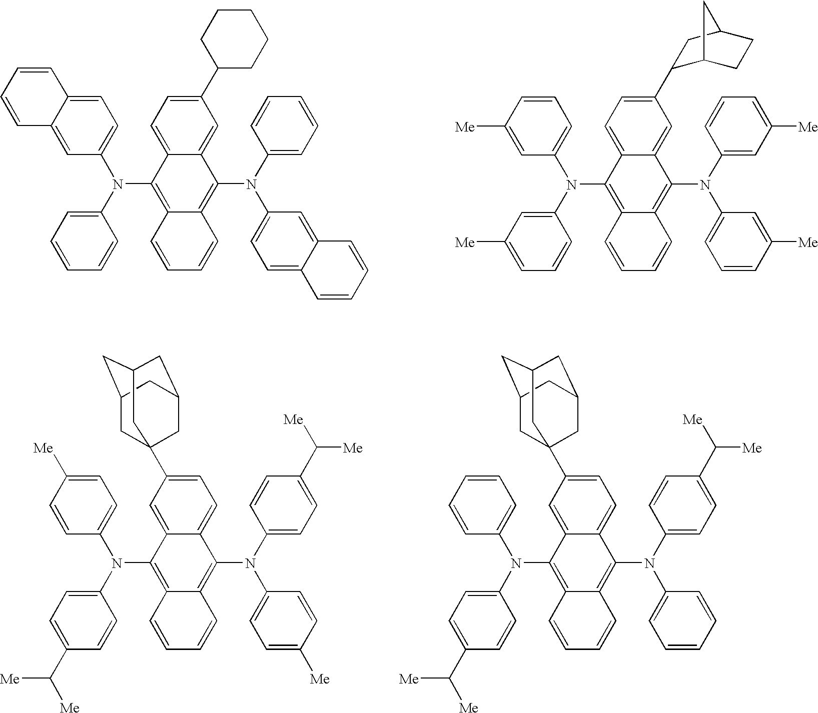 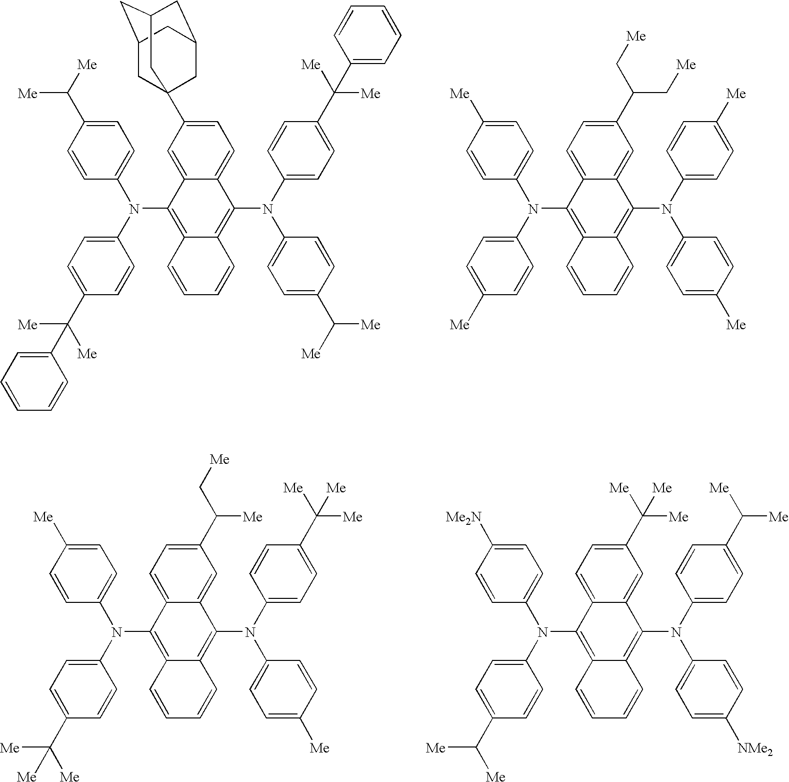 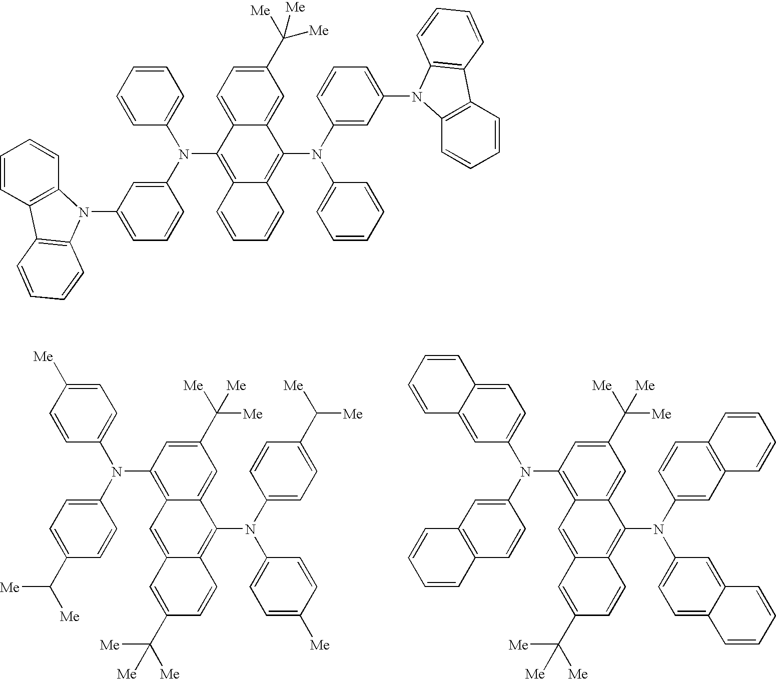 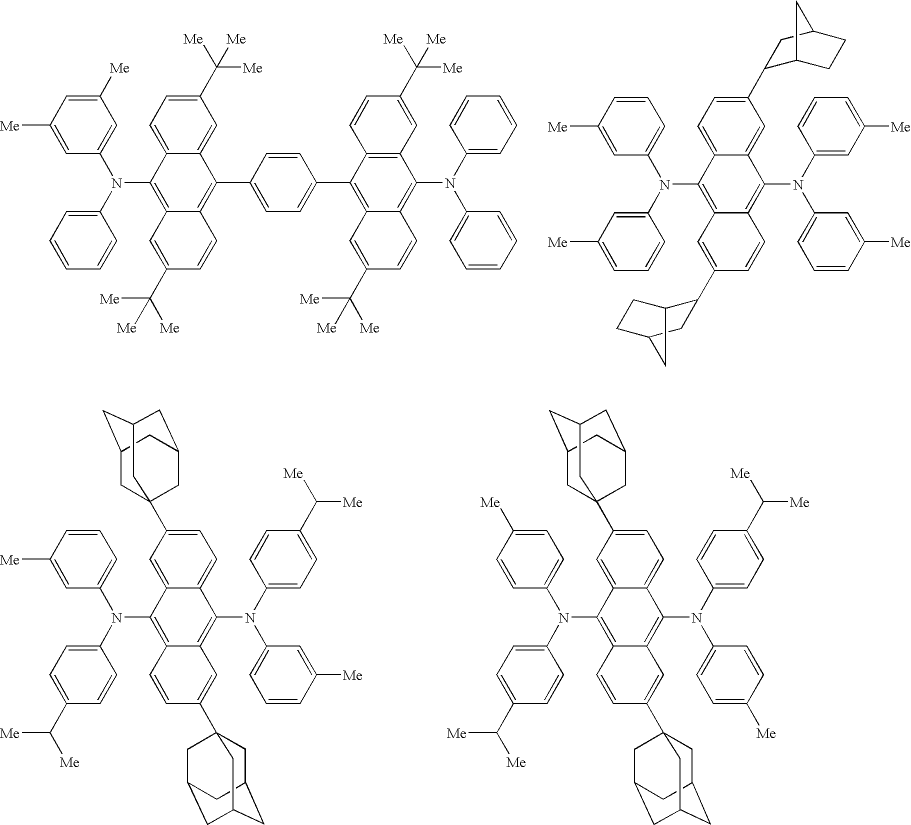 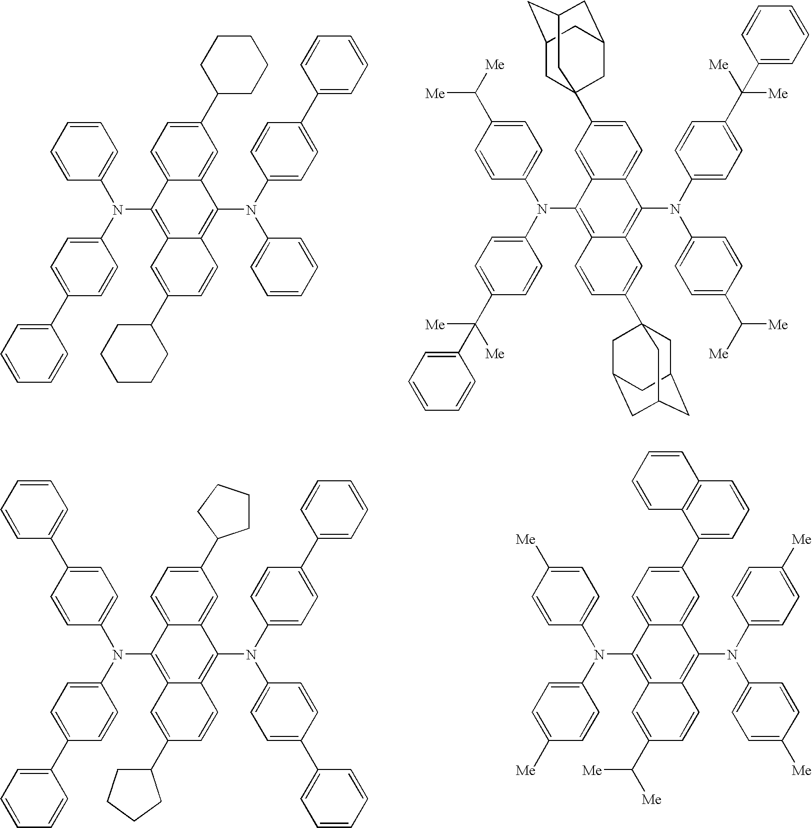 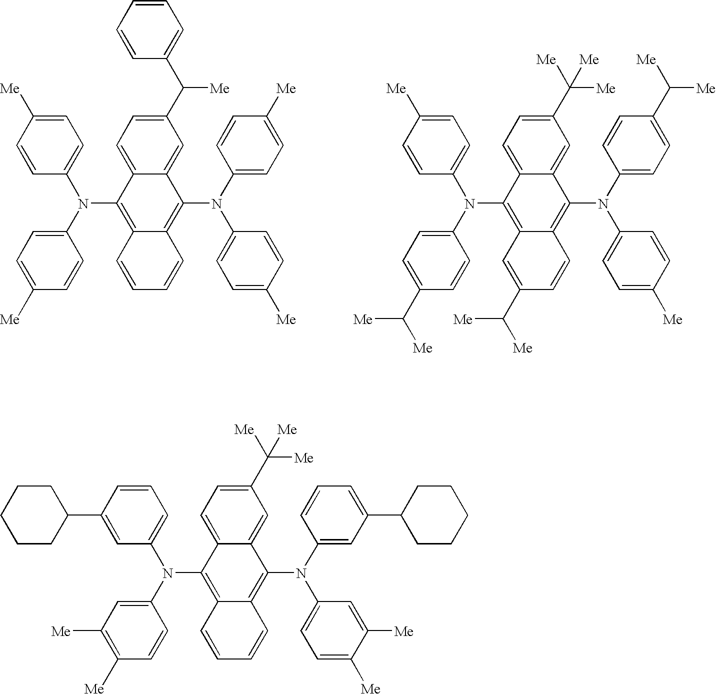 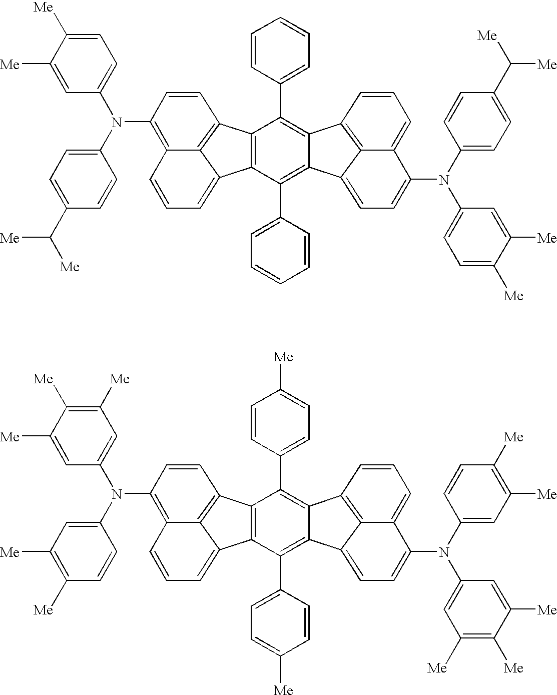 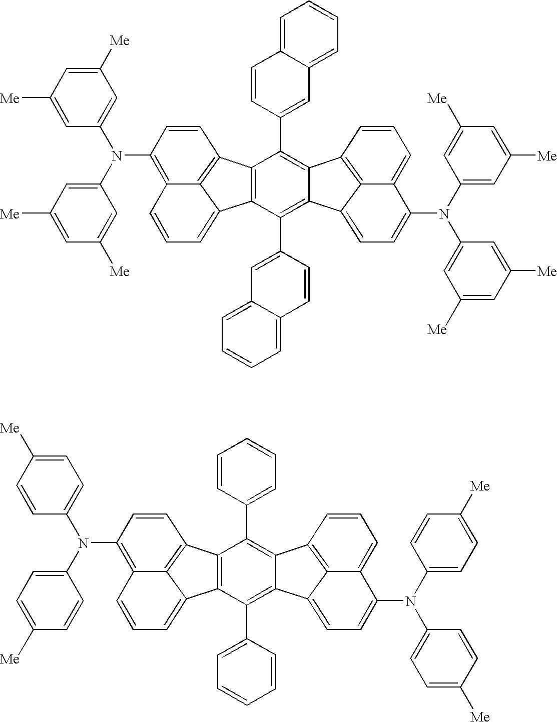 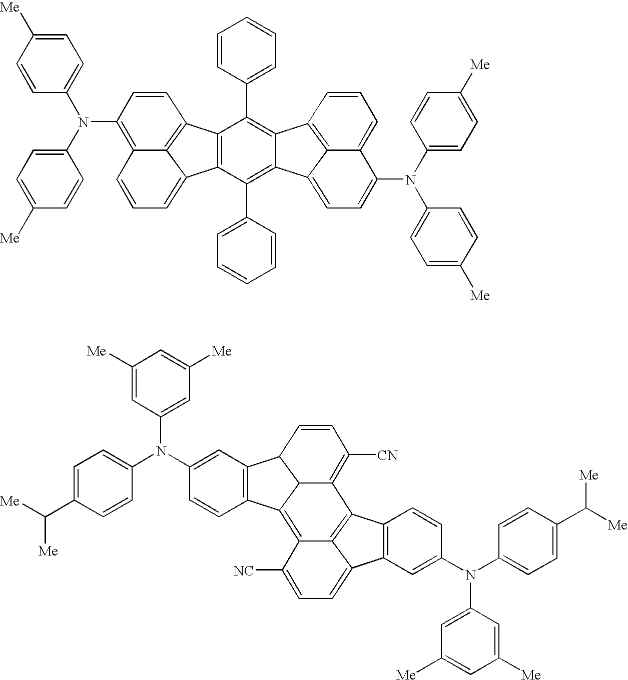 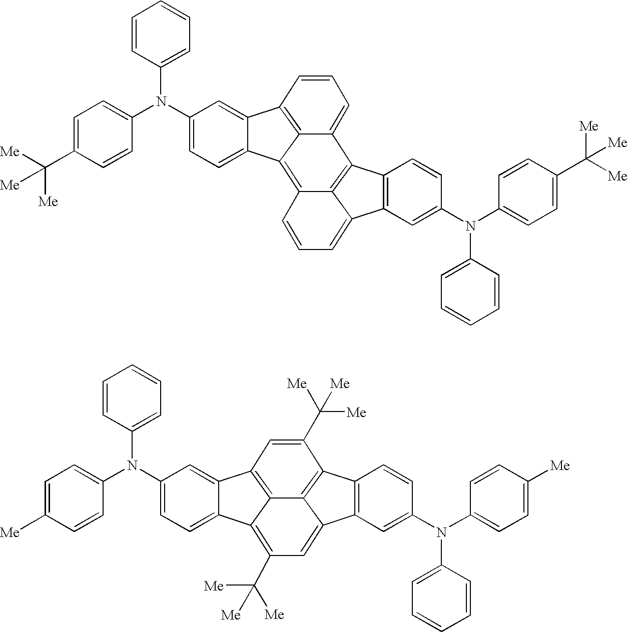 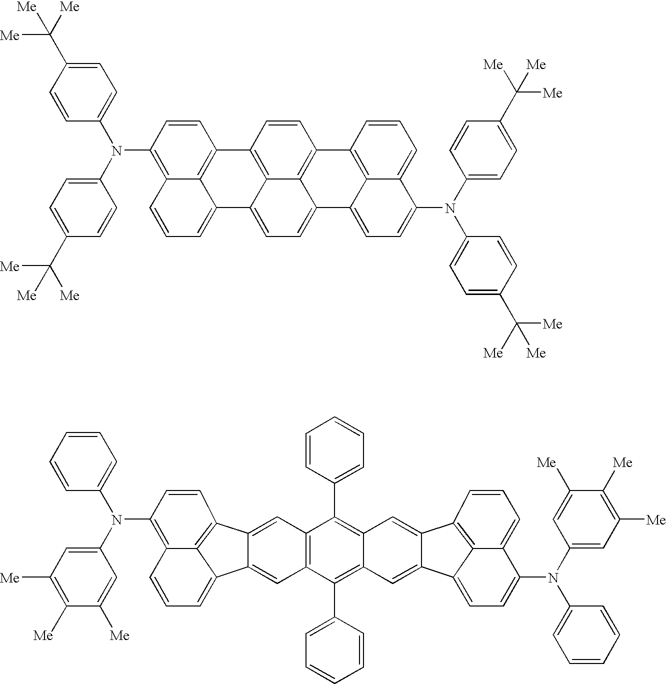 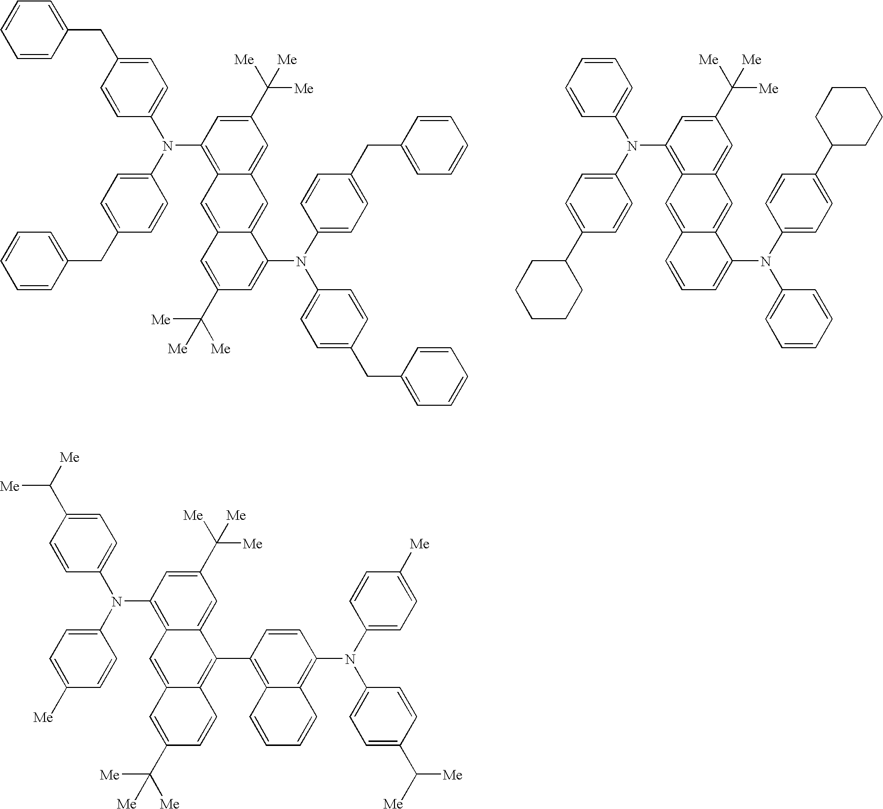 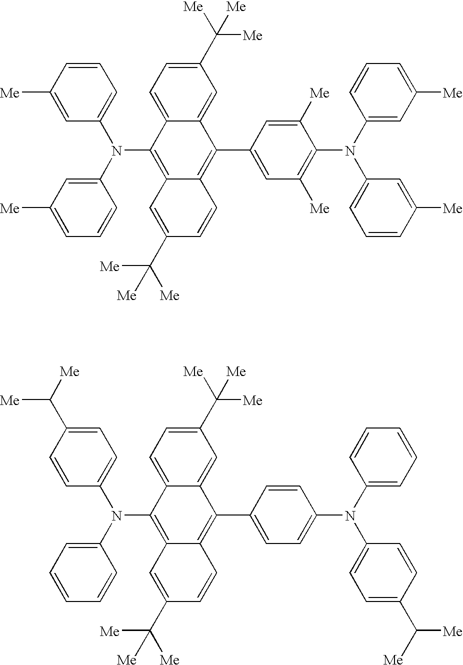 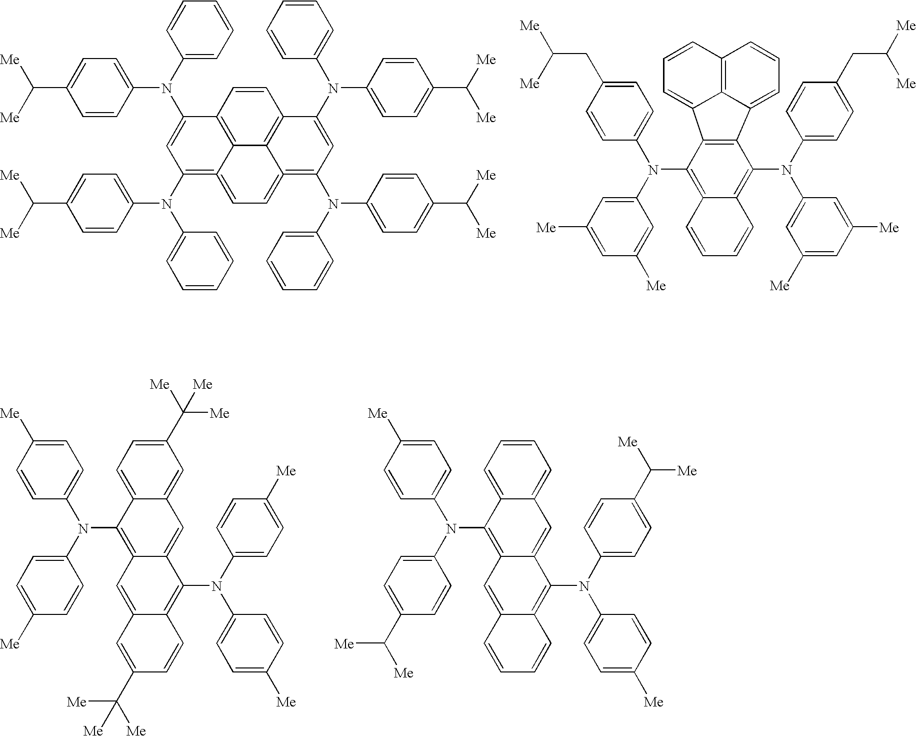 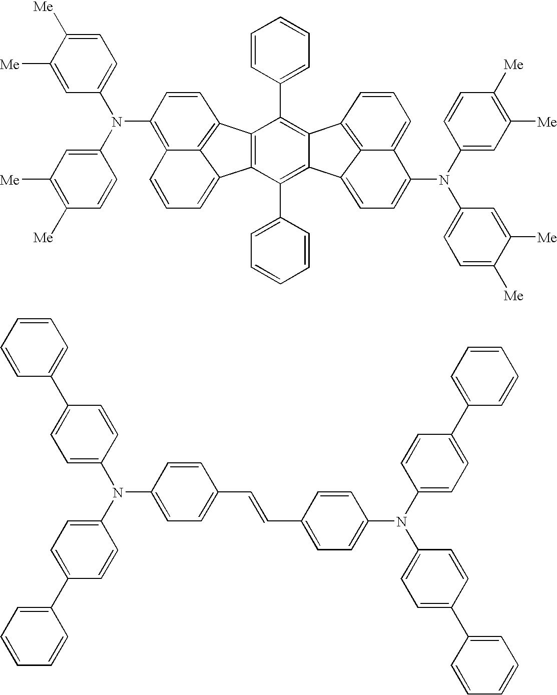 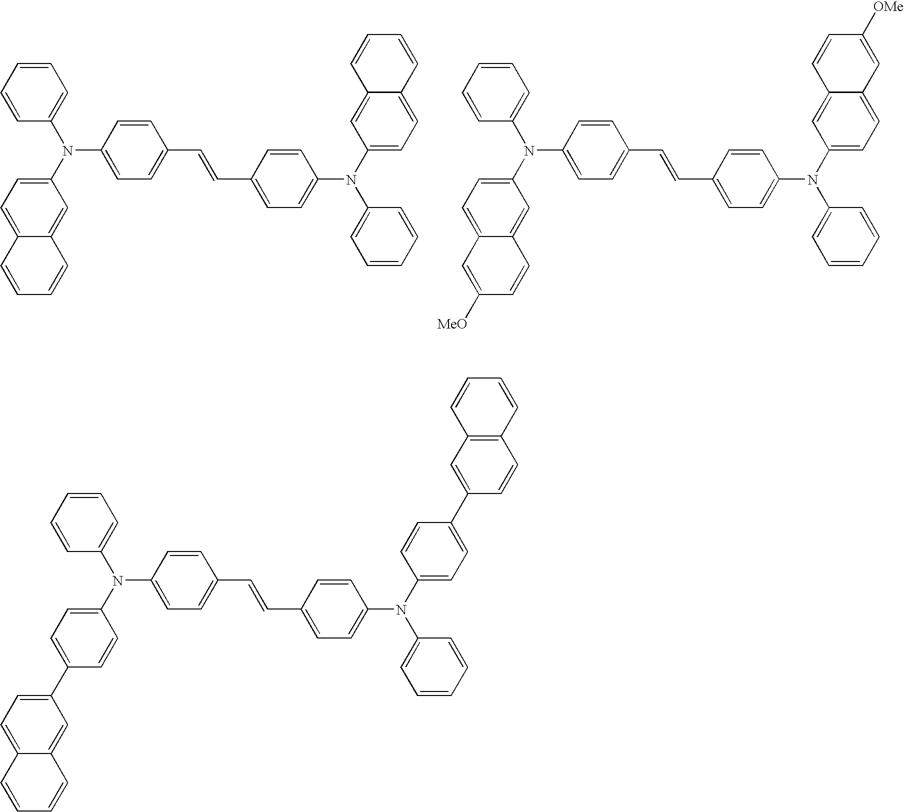 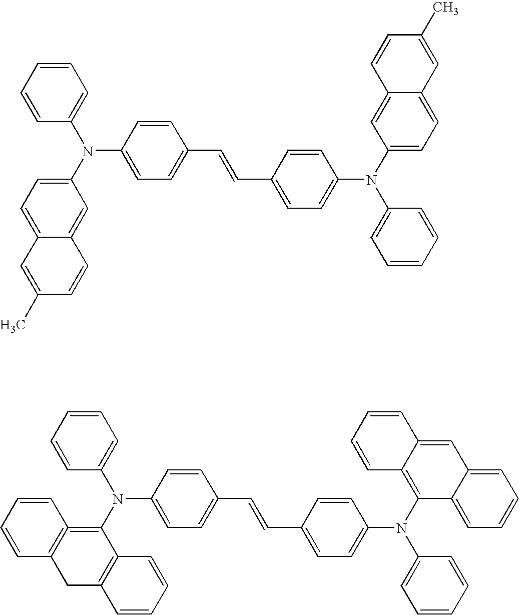 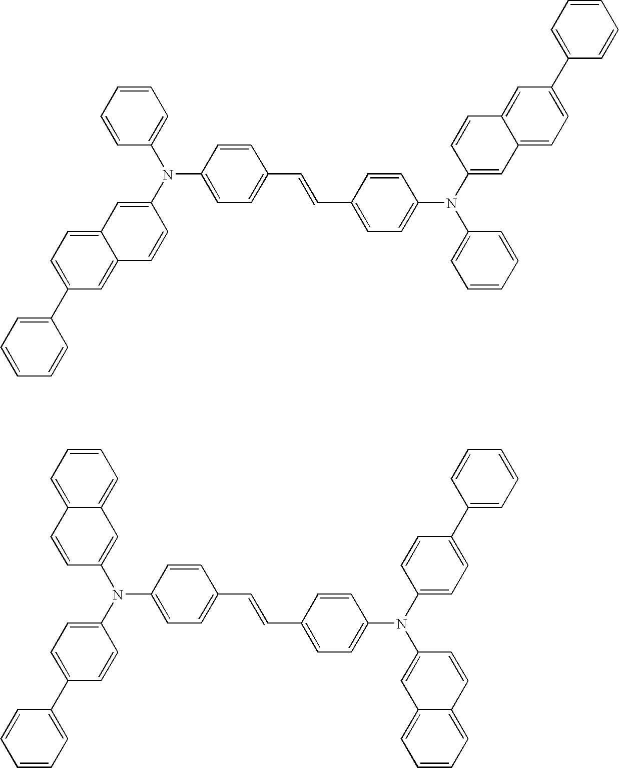 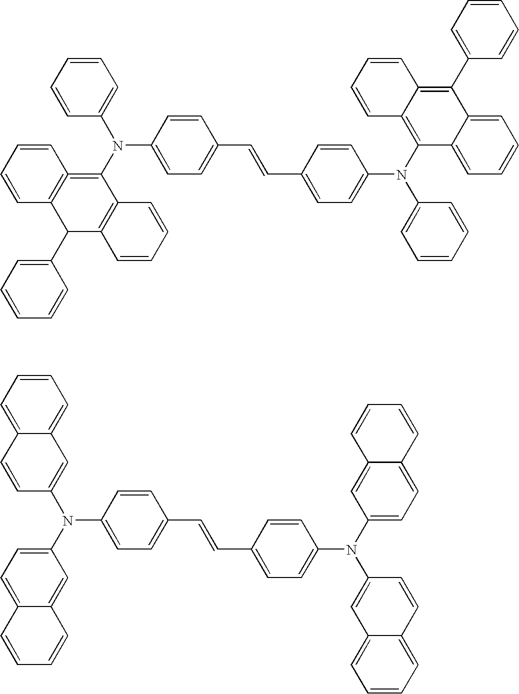 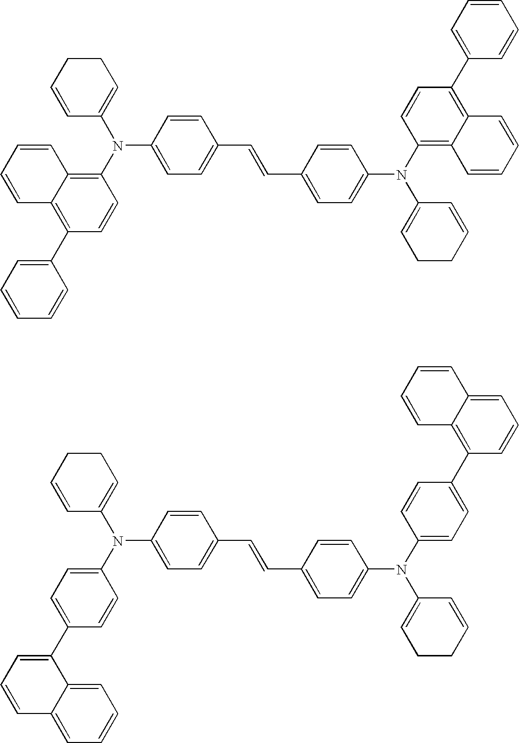 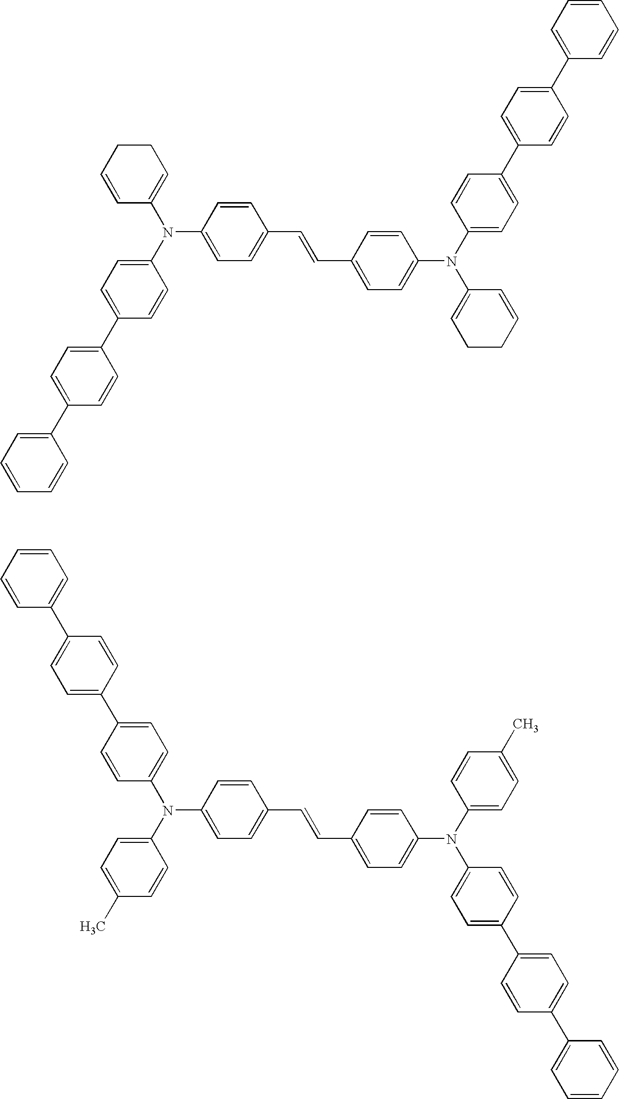 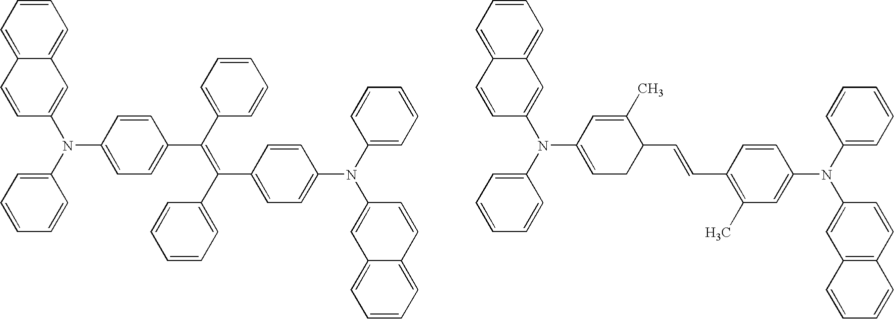 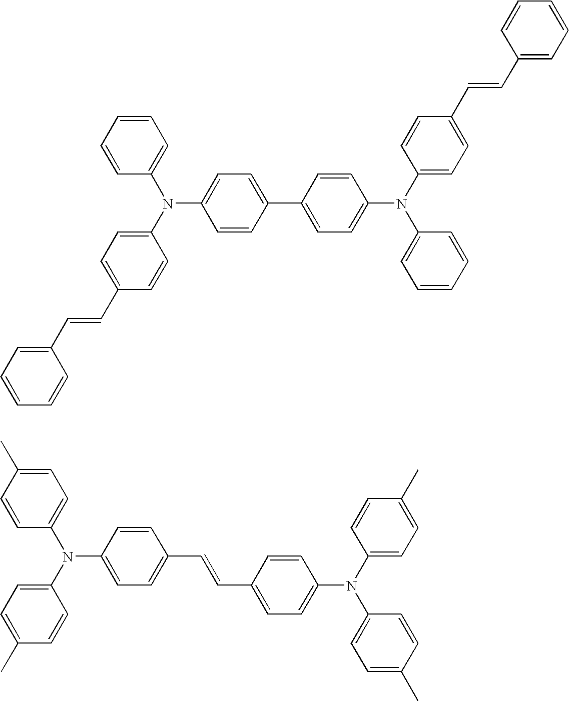 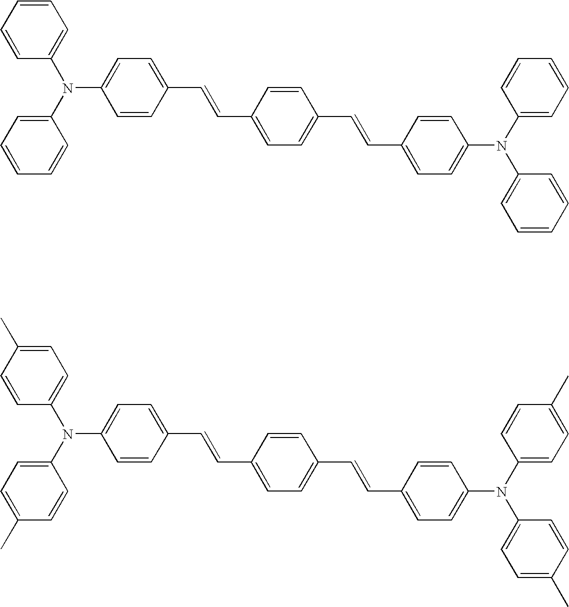 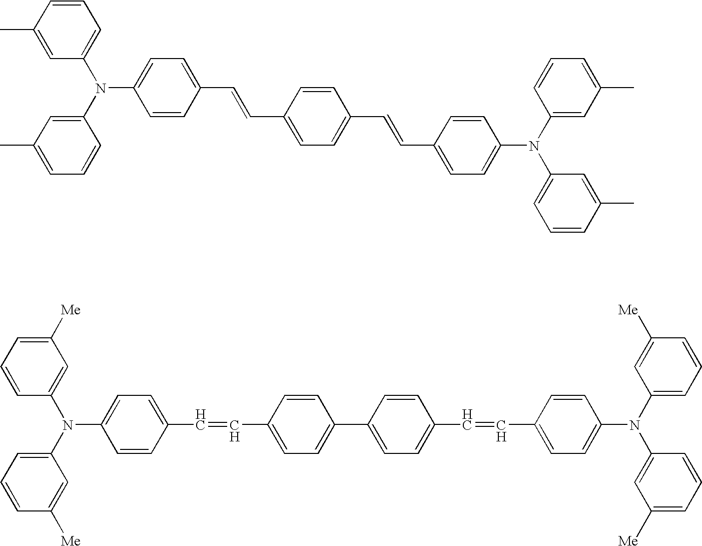 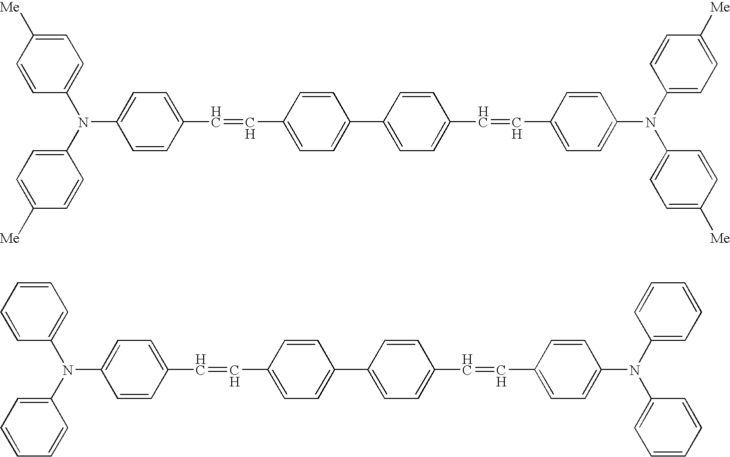 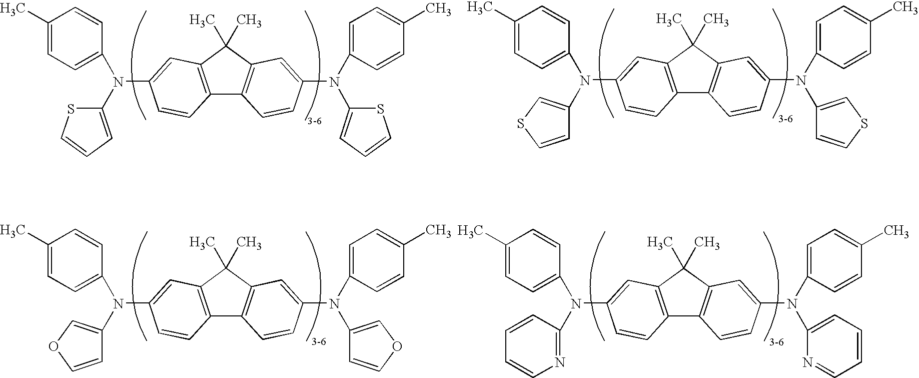 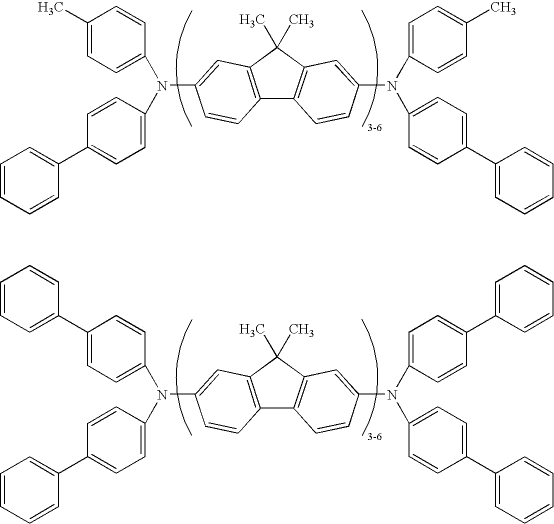 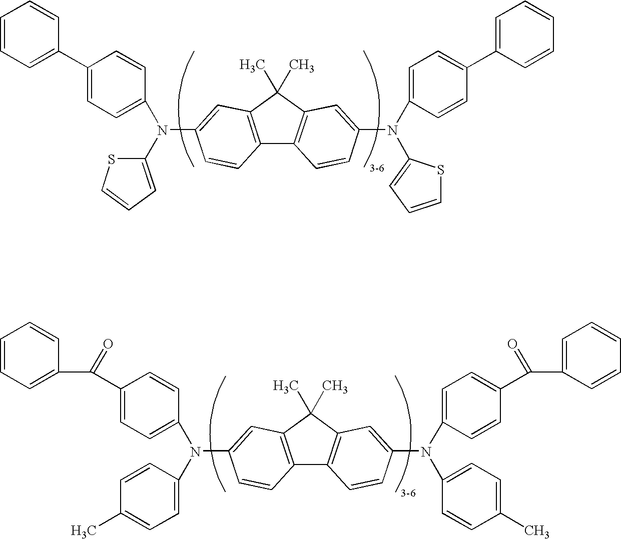 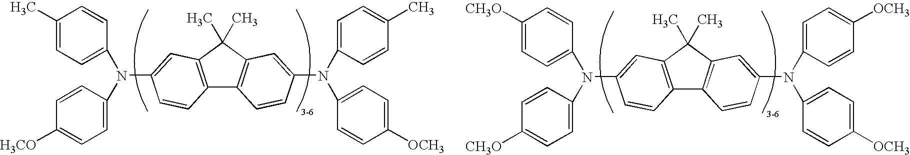 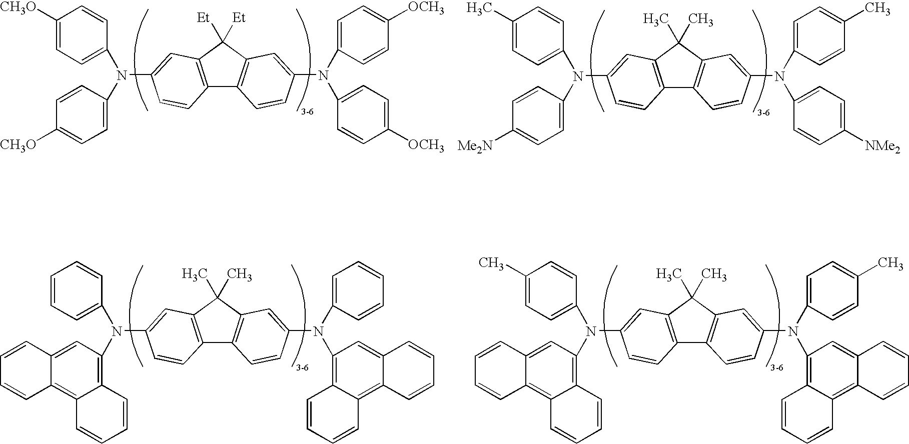 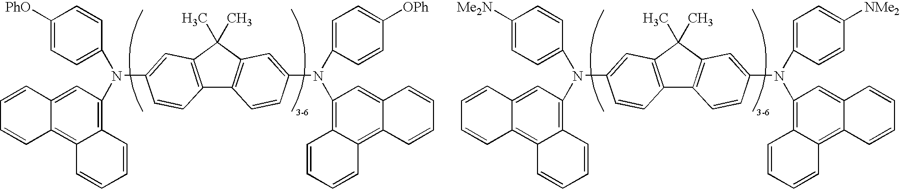 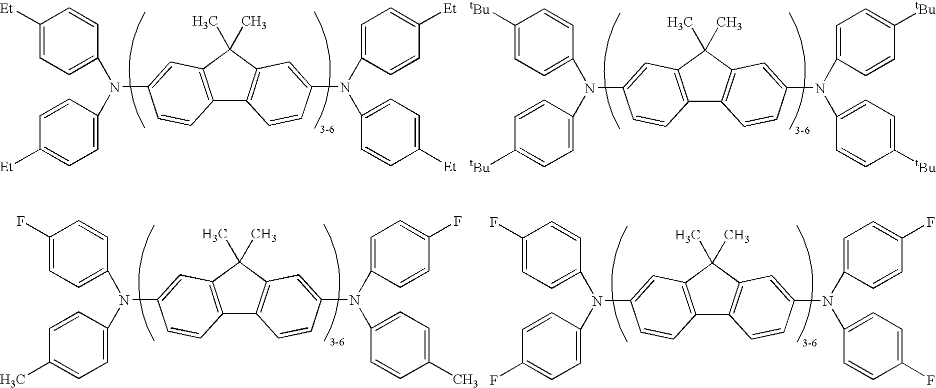 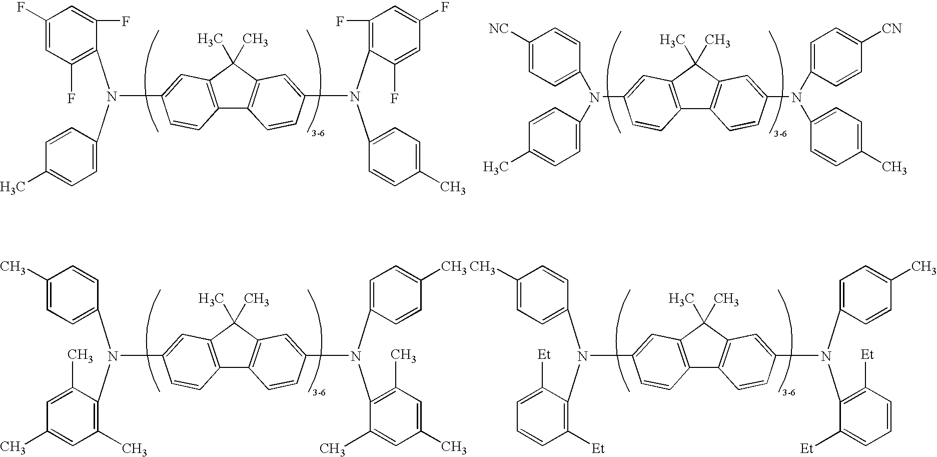 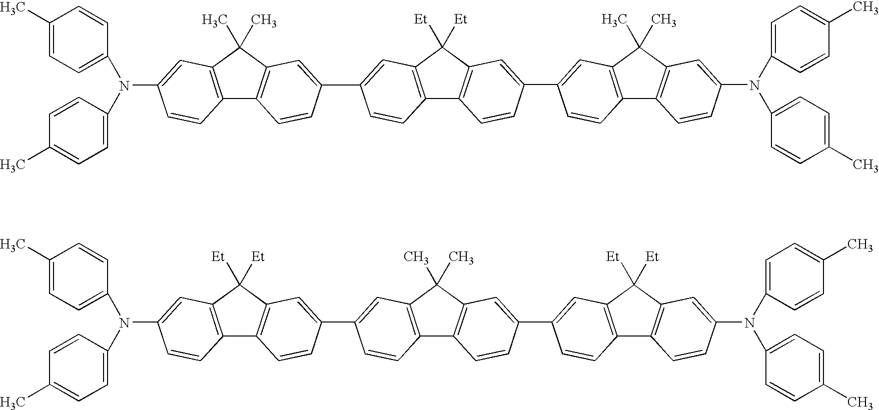 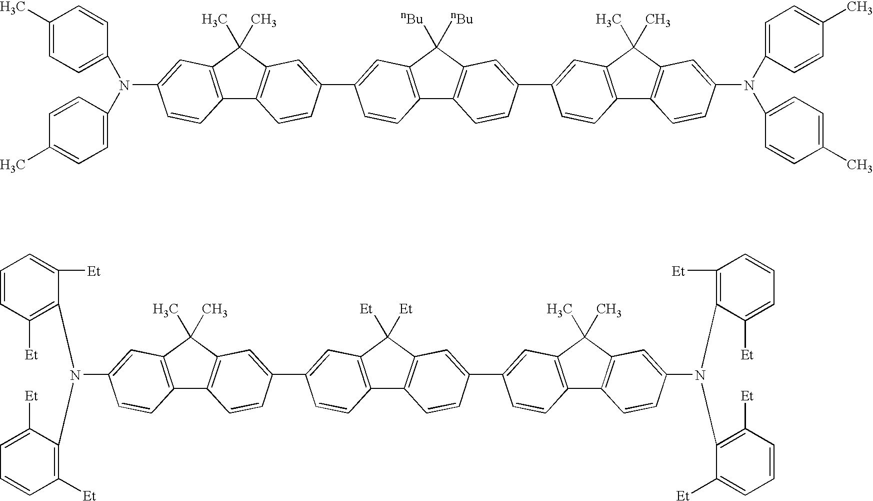 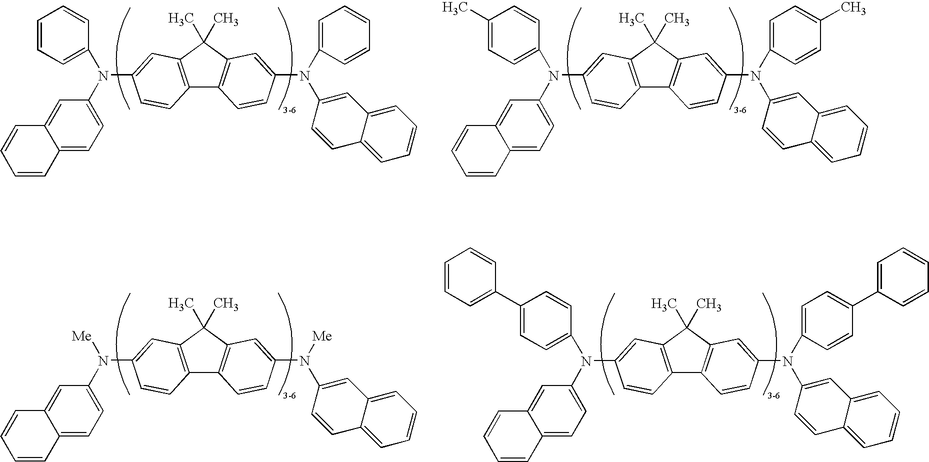 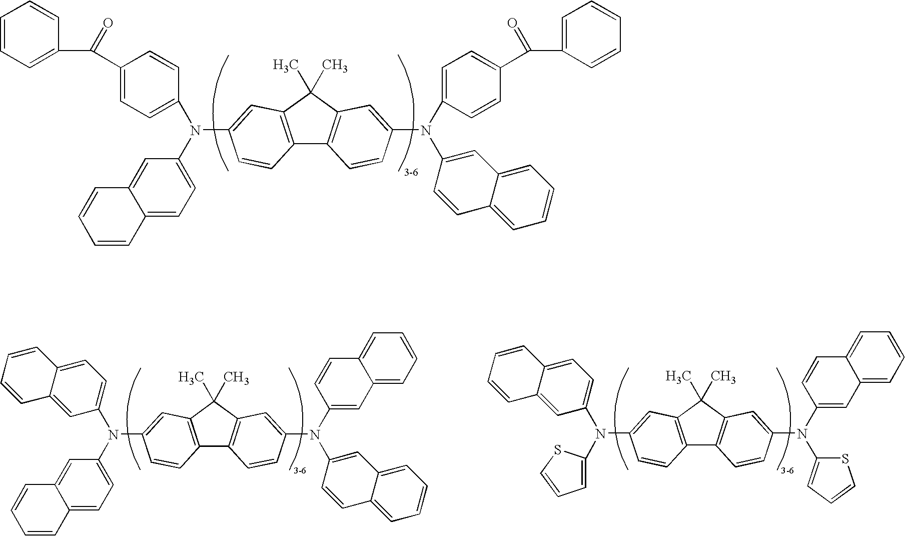 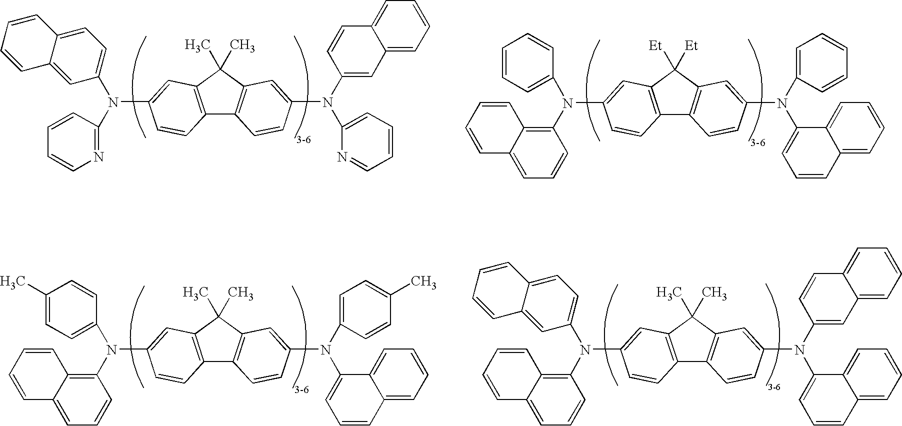 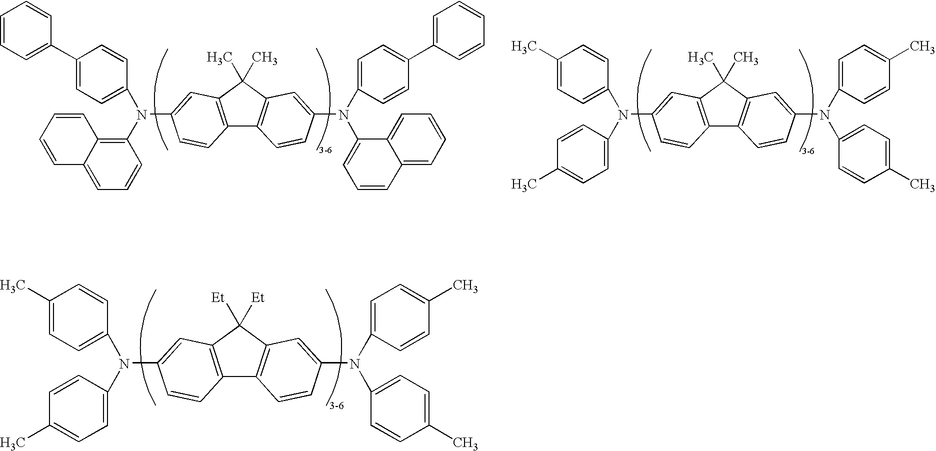
(C) Organic Solvent

Examples of the organic solvent include halogen-based hydrocarbon solvents such as dichloromethane, dichloroethane, chloroform, carbon tetrachloride, tetrachloroethane, trichloroethane, chlorobenzene, dichlorobenzene, and chlorotoluene; ether solvents such as dibutyl ether, tetrahydrofuran, dioxane and anisole; alcohol solvents such as methanol, ethanol, propanol, butanol, pentanol, hexanol, cyclohexanol, methyl cellosolve, ethyl cellosolve, and ethylene glycol; hydrocarbon solvents such as benzene, toluene, xylene, ethylbenzene, hexane, octane, and decane; and ester solvents such as ethyl acetate, butyl acetate, and amyl acetate.

Of these, halogen-based hydrocarbon solvents, hydrocarbon solvents, and ether solvents are preferable. These solvents may be used singly or in combination of two or more. The usable solvents are not limited thereto.

In the luminescent ink composition of the invention, it is preferred that the content of the anthracene derivative as the component (A) be 0.5 wt % or more. The thickness of an emitting layer of an organic EL device is normally 10 to 100 nm. The common thickness of an emitting layer is 50 nm. If the thickness of an emitting layer is smaller than 50 nm, troubles such as deterioration of emission performance or significant divergence of color tone may occur. In order to form a film with a thickness larger than 50 nm readily, it is preferred that the concentration of the anthracene derivative in the solution be 0.5 wt % or more. If the concentration is smaller than 0.5 wt %, formation of a thick film may be difficult.

Also, it is preferred that the content of the condensed aromatic ring compound substituted with an arylamino group and/or a styryl derivative substituted with an arylamino group as the component (B) be 0.001 wt % or more, particularly 0.01 wt %.

If necessary, in addition to the above-mentioned components (A) to (C), a known additive may be incorporated to the luminescent ink composition for an organic EL device of the invention.

The luminescent ink composition for an organic EL device of the invention may be formed into a film by a known wet method such as coating, inkjet, spraying, spin coating, dipping, screen coating, roll coating, and an LB method.

Next, the organic EL device of the invention will be described below.

The organic EL device of the invention is composed of one or more organic thin films being interposed between a pair of electrodes, namely, an anode and a cathode. At least one of the organic thin films is produced by using the luminescent ink composition for an organic EL device of the invention.

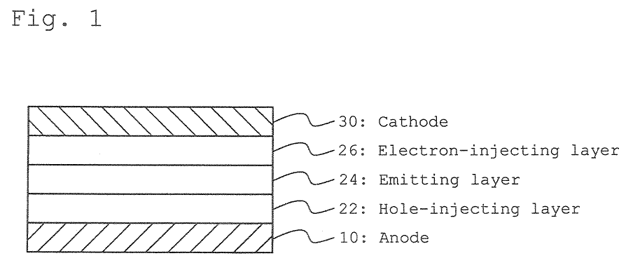

FIG. 1 is a cross-sectional view showing an embodiment of the organic EL device of the invention.

In this organic EL device, a hole-injecting layer 22, an emitting layer 24, and an electron-injecting layer 26 are interposed between a cathode 30 and an anode 10. At least one of the hole-injecting layer 22, the emitting layer 24, and the electron-injecting layer 26 may be produced using the ink composition of the invention. In the embodiment, the emitting layer 24 is formed by using the above-mentioned ink composition.

The representative device structure of the organic EL device of the invention is shown below.
(1) Anode/emitting layer/cathode
(2) Anode/hole-injecting layer/emitting layer/cathode
(3) Anode/emitting layer/electron-injecting layer/cathode
(4) Anode/hole-injecting layer/emitting layer/electron-injecting layer/cathode (FIG. 1)
(5) Anode/organic semiconductor layer/emitting layer/cathode
(6) Anode/organic semiconductor layer/electron-barrier layer/emitting layer/cathode
(7) Anode/organic semiconductor layer/emitting layer/adhesion-improving layer/cathode
(8) Anode/hole-injecting layer/hole-transporting layer/emitting layer/electron-injecting layer/cathode
(9) Anode/insulative layer/emitting layer/insulative layer/cathode
(10) Anode/inorganic semiconductive layer/insulative layer/emitting layer/insulative layer/cathode
(11) Anode/organic semiconductive layer/insulative layer/emitting layer/insulative layer/cathode
(12) Anode/insulative layer/hole-injecting layer/hole-transporting layer/emitting layer/insulative layer/cathode
(13) Anode/insulative layer/hole-injecting layer/hole-transporting layer/emitting layer/electron-injecting layer/cathode
The device structure is, however, not limited to these.

Of these, normally, the structure (8) is preferably used.

In the above devices, one or a plurality of layers interposed between the anode and the cathode corresponds to the organic thin film. All of these layers are not required to be composed of an organic compound. A layer which is composed of or contains an inorganic compound may be included.

The organic thin film produced by using the ink composition of the invention may be used as any of the above-mentioned organic layers. It is preferred that, however, the organic thin film be contained in a light-emitting region or a hole-transporting region of these structures.

In the organic EL device of the invention, it is preferred that the emission layer be the organic thin film produced by using the ink composition of the invention.

The emission layer has the following functions in combination.
(i) Injecting function: function of allowing injection of holes from anode or hole-injecting layer and injection of electrons from cathode or electron-injecting layer upon application of an electric field
(ii) Transporting function: function of moving injected carriers (electrons and holes) by the electric field
(iii) Emission function: function of providing a site for recombination of electrons and holes, leading to emission

Note that electrons and holes may be injected into the emitting layer with different degrees, or the transportation capabilities indicated by the mobility of holes and electrons may differ. It is preferable that the emitting layer move one of carriers.

As the method of forming the emitting layer, a known method such as vapor deposition, spin coating, or an LB method may be applied.

The emitting layer may also be formed by dissolving a binder such as a resin and a material compound in a solvent to obtain a solution, and forming a thin film from the solution by spin coating or the like, as disclosed in JP-A-57-51781.

In the invention, if desired, other known luminescent materials may be contained in the ink composition and resulting emitting layer insofar as the object of the invention is not impaired. Alternatively, an emitting layer containing other known luminescent materials may be stacked on the emitting layer produced by using the composition of the invention. In this case, the emitting layer may be formed by a dry method such as vacuum deposition.

Usually, the organic EL device of the invention is formed on a transparent substrate. The transparent substrate as referred to herein is a substrate for supporting the organic EL device, and is preferably a flat and smooth substrate having a transmittance of 50% or more to light rays within visible ranges of 400 to 700 nm.

Specific examples thereof include glass plates and polymer plates. Examples of the glass plate include soda-lime glass, barium/strontium-containing glass, lead glass, aluminosilicate glass, borosilicate glass, barium borosilicate glass, and quartz. Examples of the polymer plate include polycarbonate, acrylic polymer, polyethylene terephthalate, polyethersulfide, and polysulfone.

The anode of the organic EL device of the invention plays a role for injecting holes into its hole-transporting layer or emitting layer. The anode effectively has a work function of 4.5 eV or more. Tin-doped indium oxide alloy (ITO), tin oxide (NESA), gold, silver, platinum, copper, and the like may be used as the material for the anode. As the cathode, a material having a small work function is preferable in order to inject electrons into the electron-transporting layer or the emitting layer.

The anode can be formed by forming these electrode materials into a thin film by vapor deposition, sputtering or the like.

In the case where emission from the emitting layer is outcoupled through the anode, the transmittance of the anode to the emission is preferably more than 10%. The sheet resistance of the anode is preferably several hundreds Ω/□ or less. The film thickness of the anode, which varies depending upon the material thereof, is usually from 10 nm to 1 μm, preferably from 10 to 200 nm.

The hole-injecting/transporting layer is a layer for helping the injection of holes into the emitting layer to transport the holes to a light-emitting region. The hole mobility thereof is large and the ionization energy thereof is usually as small as 5.5 eV or less. Such a hole-injecting/transporting layer is preferably made of a material which can transport holes to the emitting layer at a lower electric field intensity. The hole mobility thereof is preferably at least 10⁻⁴ cm²/V second when an electric field of, e.g., 10⁴ to 10⁶ V/cm is applied.

Any materials which have the above preferable properties can be used as the material for forming the hole-injecting/transporting layer without particular limitation. The material for forming the hole-injecting/transporting layer can be arbitrarily selected from materials which have been widely used as a material transporting carriers of holes in photoconductive materials and known materials used in a hole-injecting layer of an organic EL device. For example, an aromatic tertiary amine, a hydrazone derivative, a carbazole derivative, a triazole derivative, an imidazole derivative, a polyvinyl carbozole, polyethylene dioxythiophene/polysulfonic acid (PEDOT/PSS) or the like can be given. Specific examples include triazole derivatives (see U.S. Pat. No. 3,112,197 and others), oxadiazole derivatives (see U.S. Pat. No. 3,189,447 and others), imidazole derivatives (see JP-B-37-16096 and others), polyarylalkane derivatives (see U.S. Pat. Nos. 3,615,402, 3,820,989 and 3,542,544, JP-B-45-555 and 51-10983, JP-A-51-93224, 55-17105, 56-4148, 55-108667, 55-156953 and 56-36656, and others), pyrazoline derivatives and pyrazolone derivatives (see U.S. Pat. Nos. 3,180,729 and 4,278,746, JP-A-55-88064, 55-88065, 49-105537, 55-51086, 56-80051, 56-88141, 57-45545, 54-112637 and 55-74546, and others), phenylene diamine derivatives (see U.S. Pat. No. 3,615,404, JP-B-51-10105, 46-3712 and 47-25336, JP-A-54-53435, 54-110536 and 54-119925, and others), arylamine derivatives (see U.S. Pat. Nos. 3,567,450, 3,180,703, 3,240,597, 3,658,520, 4,232,103, 4,175,961 and 4,012,376, JP-B-49-35702 and 39-27577, JP-A-55-144250, 56-119132 and 56-22437, DE1,110,518, and others), amino-substituted chalcone derivatives (see U.S. Pat. No. 3,526,501, and others), oxazole derivatives (ones disclosed in U.S. Pat. No. 3,257,203, and others), styrylanthracene derivatives (see JP-A-56-46234, and others), fluorenone derivatives (JP-A-54-110837, and others), hydrazone derivatives (see U.S. Pat. Nos. 3,717,462, JP-A-54-59143, 55-52063, 55-52064, 55-46760, 55-85495, 57-11350, 57-148749 and 2-311591, and others), stilbene derivatives (see JP-A-61-210363, 61-228451, 61-14642, 61-72255, 62-47646, 62-36674, 62-10652, 62-30255, 60-93455, 60-94462, 60-174749 and 60-175052, and others), silazane derivatives (U.S. Pat. No. 4,950,950), polysilanes (JP-A-2-204996), aniline copolymers (JP-A-2-282263), and electroconductive high molecular oligomers (in particular thiophene oligomers) disclosed in JP-A-1-211399.

The above-mentioned substances can be used as the material for the hole-injecting layer. The following can also be used: porphyrin compounds, aromatic tertiary amine compounds and styrylamine compounds (see U.S. Pat. No. 4,127,412, JP-A-53-27033, 54-58445, 54-149634, 54-64299, 55-79450, 55-144250, 56-119132, 61-295558, 61-98353 and 63-295695, and others). Aromatic tertiary amine compounds are particularly preferably used.

The following can also be given as examples: 4,4′-bis(N-(1-naphthyl)-N-phenylamino)biphenyl (abbreviated as “NPD” hereinafter), which has in the molecule thereof two condensed aromatic rings, disclosed in U.S. Pat. No. 5,061,569, and 4,4′,4″-tris(N-(3-methylphenyl)-N-phenylamino)triphenylamine (abbreviated as “MTDATA”, hereinafter), wherein three triphenylamine units are linked to each other in a star-burst form, disclosed in JP-A-4-308688.

Inorganic compounds such as p-type Si and p-type SiC as well as aromatic dimethylidene type compounds can also be used as the material for the hole-injecting layer.

The hole-injecting/transporting layer may be formed by forming the above-mentioned compound into a thin film by a known method such as vacuum deposition, spin coating, casting, an LB method or the like. The thickness of the hole-injecting/transporting layer is not particularly limited, but normally 5 nm to 5 μm.

This hole-injecting/transporting layer may be a single layer made of one or two or more of the above-mentioned materials, or may be stacked hole-injecting/transporting layers made of different compounds.

The organic semiconductor layer is a layer for helping the injection of holes or electrons into the emitting layer, and is preferably a layer having an electric conductivity of 10⁻¹⁰ S/cm or more. As the material of such an organic semiconductor layer, electroconductive oligomers such as thiophene-containing oligomers or arylamine-containing oligomers disclosed in JP-A-8-193191, and electroconductive dendrimers such as arylamine-containing dendrimers may be used.

The electron-injecting layer is a layer for helping the injection of electrons into an emitting layer, and has a large electron mobility. An adhesion-improving layer is a layer made of a material particularly good in adhesion to a cathode among such electron-injecting layers. The material used in the electron-injecting layer is preferably a metal complex of 8-hydroquinoline or a derivative thereof, or an oxadiazole derivative.

As specific examples of a metal complex of 8-hydroxyquinoline or a derivative thereof, metal chelate oxinoid compounds including a chelate of oxine (usually, 8-quinolinol or 8-hydroxyquinoline) can be given. For example, tris(8-quinolinol)aluminum (Alq) may be used in the electron-injecting layer.

An electron-transporting compound represented by the following formula can be given as the oxadiazole derivative. 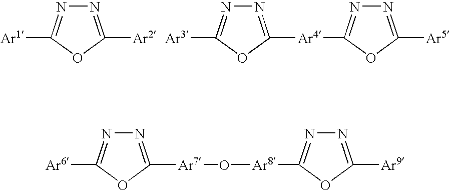
wherein Ar^{1′}, Ar^{2′}, Ar^{3′}, Ar^{5′}, Ar^{6′} and Ar^{9′} are independently a substituted or unsubstituted aryl group and may be the same or different; and Ar^{4′}, Ar^{7′} and Ar^{8′} are independently a substituted or unsubstituted arylene group and may be the same or different.

As examples of the aryl group, a phenyl group, a biphenyl group, an anthranyl group, a perylenyl group, and a pyrenyl group can be given. As examples of the arylene group, a phenylene group, a naphthylene group, a biphenylene group, an anthranylene group, a perylenylene group, a pyrenylene group, and the like can be given. As the substituent, an alkyl group having 1 to 10 carbon atoms, an alkoxy group having 1 to 10 carbon atoms, a cyano group, or the like can be given The electron-transporting compound is preferably one from which a thin film can be formed.

The following compounds can be given as specific examples of the electron transporting compound.

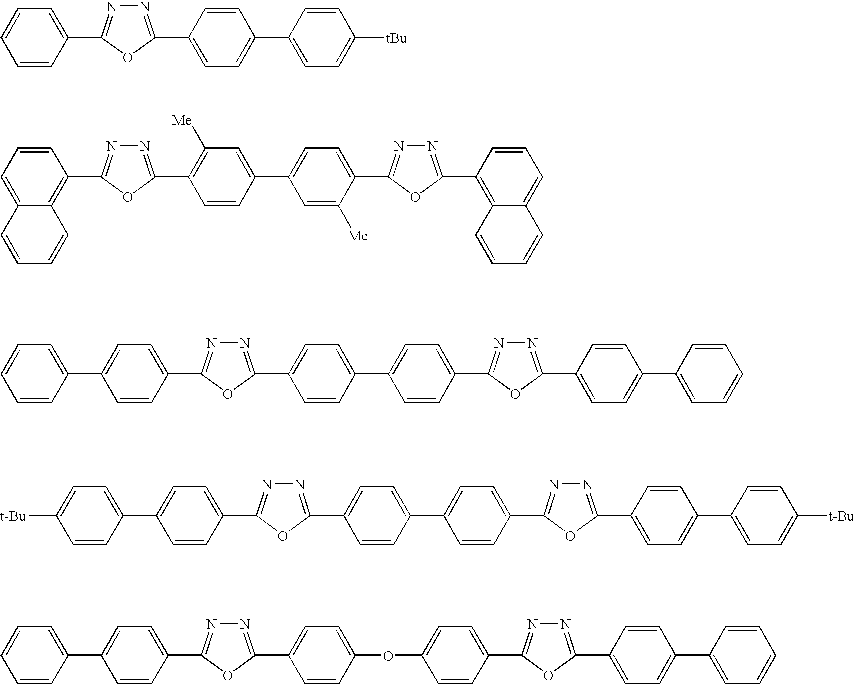

A preferred embodiment of the organic EL device of the invention is a device containing a reducing dopant in an interfacial region between its electron-transferring region or cathode and organic layer. The reducing dopant is defined as a substance which can reduce an electron transferring compound. Accordingly, various substances which have certain reducing properties can be used. For example, at least one substance can be preferably used which is selected from the group consisting of alkali metals, alkaline earth metals, rare earth metals, alkali metal oxides, alkali metal halides, alkaline earth metal oxides, alkaline earth metal halides, rare earth metal oxides, rare earth metal halides, alkali metal organic complexes, alkaline earth metal organic complexes, and rare earth metal organic complexes.

More specifically, preferable reducing agents include at least one alkali metal selected from Na (work function: 2.36 eV), K (work function: 2.28 eV), Rb (work function: 2.16 eV) and Cs (work function 1.95 eV); and at least one alkaline earth metal selected from the group consisting of Ca (work function: 2.9 eV), Sr (work function: 2.0 to 2.5 eV) and Ba (work function: 2.52 eV). A substance having a work function of 2.9 eV or less is particularly preferable.

Among these, a more preferable reducing dopant is at least one alkali metal selected from the group consisting of K, Rb and Cs. Even more preferable is Rb or Cs. Most preferable is Cs. These alkali metals are particularly high in reducing ability. Thus, the addition of a relatively small amount thereof to an electron-injecting zone improves the luminance of the organic EL device and make the lifetime thereof long. As the reducing dopant having a work function of 2.9 eV or less, a combination of two or more out of these alkali metals is also preferred. Particularly preferred is a combination containing Cs, for example, combinations of Cs and Na, Cs and K, Cs and Rb, or Cs, Na and K. The combination containing Cs makes it possible to exhibit the reducing ability efficiently. The luminance of the organic EL device can be improved and the lifetime thereof can be made long by the addition thereof to its electron-injecting zone.

In the organic EL device, an electron-injecting layer made of an insulator or a semiconductor may further be provided between a cathode and an organic layer. By providing the layer, current leakage can be effectively prevented to improve the injection of electrons.

As the insulator, at least one metal compound selected from the group consisting of alkali metal calcogenides, alkaline earth metal calcogenides, halides of alkali metals and halides of alkaline earth metals can be preferably used. When the electron-injecting layer is formed of the alkali metal calcogenide or the like, the injection of electrons can be preferably further improved. Specifically preferable alkali metal calcogenides include Li₂O, LiO, Na₂S, Na₂Se and NaO and preferable alkaline earth metal calcogenides include CaO, BaO, SrO, BeO, BaS and CaSe. Preferable halides of alkali metals include LiF, NaF, KF, LiCl, KCl and NaCl. Preferable halides of alkaline earth metals include fluorides such as CaF₂, BaF₂, SrF₂, MgF₂ and BeF₂ and halides other than fluorides.

Examples of the semiconductor include oxides, nitrides or oxynitrides containing at least one element selected from Ba, Ca, Sr, Yb, Al, Ga, In, Li, Na, Cd, Mg, Si, Ta, Sb and Zn, and combinations of two or more thereof. An inorganic compound forming an electron-transporting layer is preferably a microcrystalline or amorphous insulative thin film. When the electron-transporting layer is formed of the insulative thin films, more uniformed thin film is formed whereby pixel defects such as a dark spot are decreased. Examples of such an inorganic compound include the above-mentioned alkali metal calcogenides, alkaline earth metal calcogenides, halides of alkali metals, and halides of alkaline earth metals.

For the cathode, the following may be used: an electrode substance made of a metal, an alloy or an electroconductive compound, or a mixture thereof which has a small work function (4 eV or less). Specific examples of the electrode substance include sodium, sodium-potassium alloys, magnesium, lithium, magnesium/silver alloys, aluminum/aluminum oxide, aluminum/lithium alloys, indium, and rare earth metals.

This cathode can be formed by making the electrode substances into a thin film by vapor deposition, sputtering or some other method. In the case where emission from the emitting layer is outcoupled through the cathode, it is preferred to make the transmittance of the cathode to the emission larger than 10%. The sheet resistance of the cathode is preferably several hundreds Ω/□ or less, and the film thickness thereof is usually from 10 nm to 1 μm, preferably from 50 to 200 nm.

In the organic EL device, pixel defects based on leakage or a short circuit are easily generated since an electric field is applied to the super thin film. In order to prevent this, it is preferred to insert an insulative thin layer between the pair of electrodes.

Examples of the material used in the insulative layer include aluminum oxide, lithium fluoride, lithium oxide, cesium fluoride, cesium oxide, magnesium oxide, magnesium fluoride, calcium oxide, calcium fluoride, aluminum nitride, titanium oxide, silicon oxide, germanium oxide, silicon nitride, boron nitride, molybdenum oxide, ruthenium oxide, and vanadium oxide. A mixture or laminate thereof may be used.

The film thickness of each of the organic layers forming the organic thin layer in the organic EL device of the invention is not particularly limited. In general, defects such as pinholes are easily generated when the film thickness is too small. Conversely, a high applied voltage becomes necessary, leading to low efficiency, when the film thickness is too large. Usually, therefore, the film thickness is preferably in the range of several nanometers to one micrometer.

The organic EL device can be fabricated by forming an anode, an emitting layer, optionally forming a hole-injecting layer or an electron-injecting layer, and further forming a cathode by use of the materials and methods exemplified above. The organic EL device can be fabricated in the order reverse to the above, i.e., the order from a cathode to an anode.

### EXAMPLES

The invention will be described below by Examples. The structures of the compounds used in the examples are shown below. 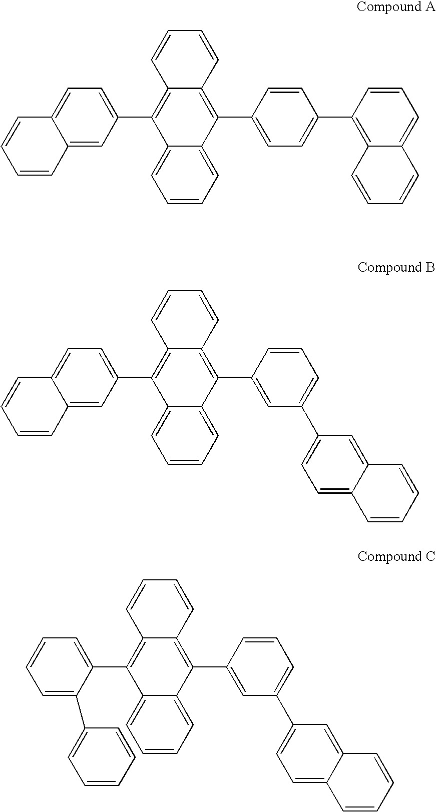 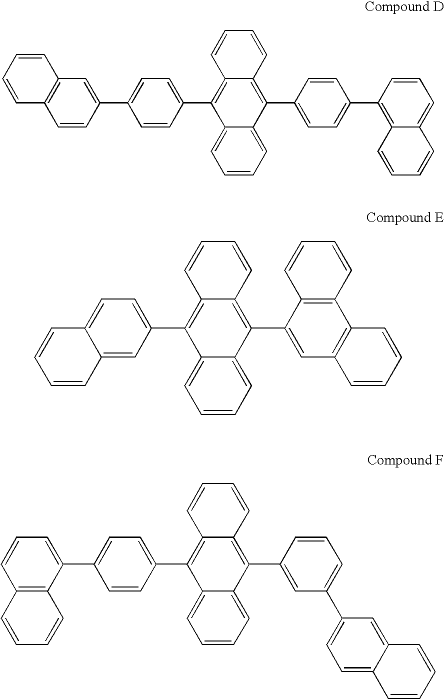 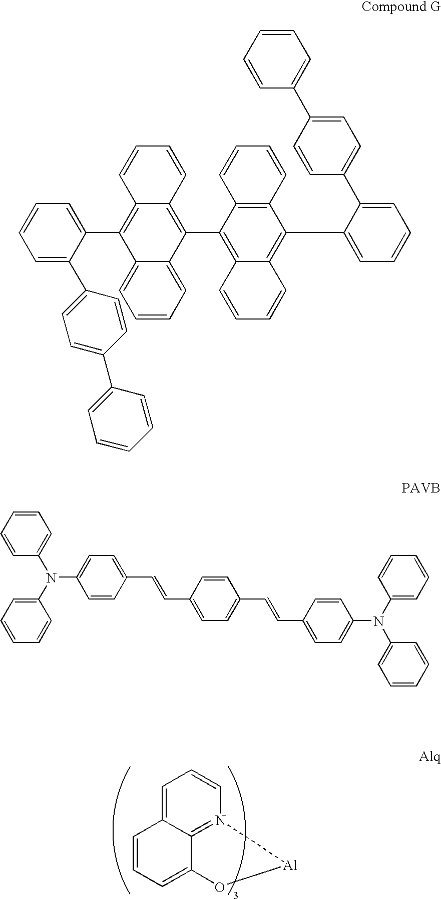
[Luminescent Ink Composition for Organic EL Device]

### Example 1

0.01 g of the compound A as the component (A), 0.001 g of PAVB as the component (B), and 1 g of toluene as the component (C) were placed in a glass bottle, and stirred.

Absence of insoluble matters was visually confirmed.

### Example 2

The same procedures as in Example 1 were followed, except that the compound B was used instead of the compound A. Absence of insoluble matters in the resultant solution was visually confirmed.

### Example 3

The same procedures as in Example 1 were followed, except that the compound C was used instead of the compound A. Absence of insoluble matters in the resultant solution was visually confirmed.

### Example 4

The same procedures as in Example 1 were followed, except that the compound D was used instead of the compound A. Absence of insoluble matters in the resultant solution was visually confirmed.

### Example 5

The same procedures as in Example 1 were followed, except that the compound E was used instead of the compound A. Absence of insoluble matters in the resultant solution was visually confirmed.

### Example 6

The same procedures as in Example 1 were followed, except that the compound F was used instead of the compound A. Absence of insoluble matters in the resultant solution was visually confirmed.

### Example 7

The same procedures as in Example 1 were followed, except that the compound G was used instead of the compound A. Absence of insoluble matters in the resultant solution was visually confirmed.

[Formation of Organic Thin Film]

### Example 8

A thin film was prepared by spin coating using a solution obtained by dissolving 0.07 g of the compound G and 0.007 g of PAVB in 10 g of toluene (a 0.7 wt % toluene solution). The thickness of the resultant film was 50 nm.

[Organic EL Device]

### Example 9

A grass substrate of 25 mm by 75 mm by 1.1 mm thick with an ITO transparent electrode (GEOMATEC Co., Ltd.) was subjected to ultrasonic cleaning with isopropyl alcohol for 5 minutes, and cleaned with ultraviolet rays and ozone for 30 minutes.

On the substrate, a 100 nm-thick film of polyethylene dioxythiophene/polystyrenesulfonic acid (PEDOT/PSS), as a hole-injecting layer, was formed by spin coating.

Subsequently, a toluene solution containing 1 wt % of the compound A and 0.1 wt % of PAVB was formed into a film by spin coating on the hole-injecting layer, whereby an emitting layer was obtained. The thickness of the emitting layer was 50 nm.

Then, a 10 nm-thick tris(8-quinolinol)aluminum film (hereinafter abbreviated as “Alq film”) was formed thereon. This Alq film functions as an electron-transporting layer.

Then, Li as a reductive dopant (Li source: manufactured by SAES Getters Co., Ltd.) and Alq were co-deposited, whereby an Alq:Li film was formed as an electron-injecting layer (cathode).

Metal aluminum was deposited thereon to form a metal cathode, thereby fabricating an organic EL device.

A DC voltage of 5.5 V was applied to this device. A current density was 3.5 mA/cm² and blue emission with a luminance of 110 cd/m² was observed. The luminous efficiency and the half life of luminance from 100 cd/m² at a constant driving current are shown in Table 1.

TABLE 1

| | | | | Half life |
|---|---|---|---|---|
| | Compound | Compound | Luminous | of |
| | for | for | efficiency | luminance |
| | component A | component B | (cd/A) | (h) |
| Example 9 | Compound A | PAVB | 3.5 | 300 |
| Example | Compound G | PAVB | 3.4 | 200 |
| 10 | | | | |
| Example | Compound A | Compound H | 3.3 | 320 |
| 11 | | | | |
| Example | Compound A | Compound I | 3.0 | 300 |
| 12 | | | | |
| Example | Compound A | Compound J | 3.2 | 350 |
| 13 | | | | |

### Example 10

An organic EL device was fabricated and evaluated in the same manner as in Example 9, except that the compound G shown in Table 1 was used instead of the compound A. The results are shown in Table 1.

### Example 11

An organic EL device was fabricated and evaluated in the same manner as in Example 9, except that the compound H shown below was used instead of PAVB. For this device, blue emission was observed at a DC voltage of 5 V. The results are shown in Table 1.

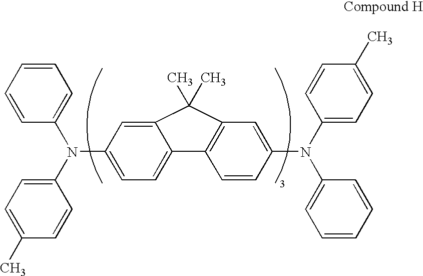

### Example 12

An organic EL device was fabricated and evaluated in the same manner as in Example 9, except that the compound I shown below was used instead of PAVB. For this device, blue emission was observed at a DC voltage of 5 V. The results are shown in Table 1.

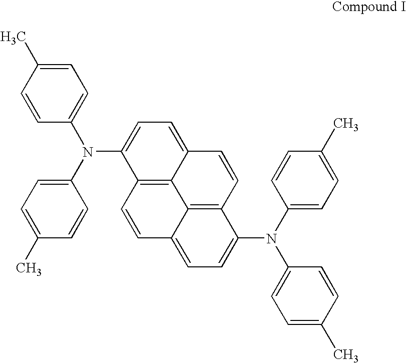

### Example 13

An organic EL device was fabricated and evaluated in the same manner as in Example 9, except that the compound J shown below was used instead of PAVB. For this device, blue emission was observed at a DC voltage of 5 V. The results are shown in Table 1.

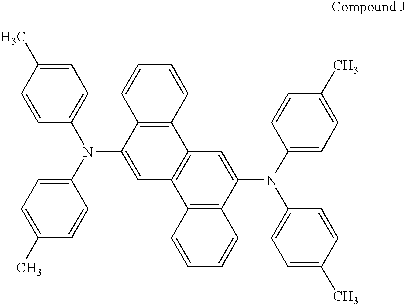

### INDUSTRIAL APPLICABILITY

The luminescent ink composition for an organic EL device of the invention can form organic thin films constituting an organic EL device with a high productivity since it contains a luminescent low-molecular material with a high solubility.

The organic EL device of the invention can be suitably used as a planar emitting body such as a flat panel display, backlight of a copier, a printer, or a liquid crystal display, light sources for instruments, a display panel, a navigation light, and the like.

1. A luminescent ink composition for an organic electroluminescent device comprising:
(A) an anthracene derivative represented by the following formula (1);
(B) a condensed aromatic ring compound substituted with an arylamino group and/or a styryl derivative substituted with an arylamino group; and
(C) an organic solvent 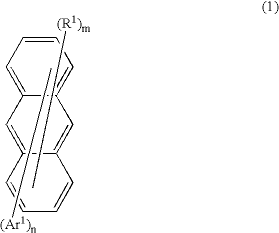
wherein Ar¹ is an aryl group with 6 to 50 nucleus carbon atoms which may have a substituent or a heteroaryl group with 5 to 50 nucleus atoms which may have a substituent;
R¹ is a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group;
n and m are an integer; n+m is 10 or less; and
Ar¹s or R¹s may be the same or different when n or m is 2 or more.

2. The luminescent ink composition for an organic electroluminescent device according to claim 1 wherein the anthracene derivative is a derivative represented by the following formula (2): 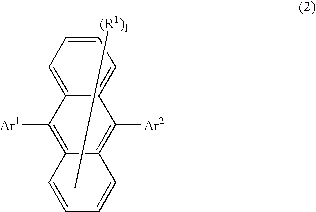
wherein Ar¹ and Ar² are an aryl group with 6 to 50 nucleus carbon atoms which may have a substituent or a heteroaryl group with 5 to 50 nucleus atoms which may have a substituent; Ar¹ and Ar² are different;
R¹ is a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group;
l is an integer of 0 to 8; and
R¹s may be the same or different when 1 is 2 or more.

3. The luminescent ink composition for an organic electroluminescent device according to claim 1 or 2 wherein the anthracene derivative is a derivative represented by the following formula (3): 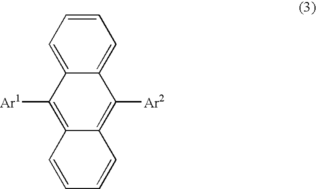
wherein Ar¹ and Ar² are an aryl group with 6 to 50 nucleus carbon atoms which may have a substituent or a heteroaryl group with 5 to 50 nucleus atoms which may have a substituent.

4. The luminescent ink composition for an organic electroluminescent device according to claim 1 wherein the anthracene derivative is a derivative represented by the following formula (4): 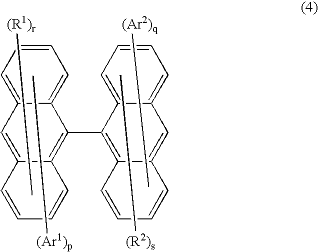
wherein Ar¹ and Ar² are an aryl group with 6 to 50 nucleus carbon atoms which may have a substituent or a heteroaryl group with 5 to 50 nucleus atoms which may have a substituent; Ar¹ and Ar² may be the same or different;
R¹ and R² are a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group; R¹ and R² may be the same or different;
p and q are an integer of 1 to 8; r and s are an integer of 0 to 8; and
Ar¹s, Ar²s, R¹s or R²s may be the same or different when p, q, r or s is 2 or more.

5. The luminescent ink composition for an organic electroluminescent device according to claim 4 wherein the anthracene derivative is a derivative represented by the following formula (5): 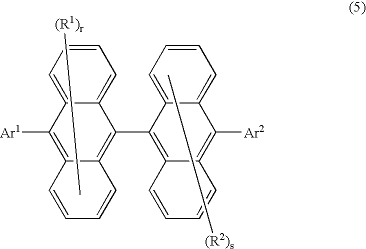
wherein Ar¹ and Ar² are an aryl group with 6 to 50 nucleus carbon atoms which may have a substituent or a heteroaryl group with 5 to 50 nucleus atoms which may have a substituent; Ar¹ and Ar² may be the same or different;
R¹ and R² are a substituted or unsubstituted alkyl group with 1 to 50 carbon atoms, a substituted or unsubstituted alkoxy group with 1 to 50 carbon atoms, a substituted or unsubstituted aralkyl group with 7 to 50 carbon atoms, a substituted or unsubstituted aryloxy group with 5 to 50 nucleus atoms, a substituted or unsubstituted arylthio group with 5 to 50 nucleus atoms, a substituted or unsubstituted carboxyl group with 1 to 50 carbon atoms, a halogen group, a cyano group, a nitro group or a hydroxyl group; R¹ and R² may be the same or different;
r and s are an integer of 0 to 8; and
R¹s or R²s may be the same or different when r or s is 2 or more.

6. The luminescent ink composition for an organic electroluminescent device according to any one of claims 1 to 5 which contains 0.5 wt % or more of the anthracene derivative.

7. The luminescent ink composition for an organic electroluminescent device according to any one of claims 1 to 6 wherein the condensed aromatic ring compound substituted with an arylamino group is a compound represented by the following formula (6): 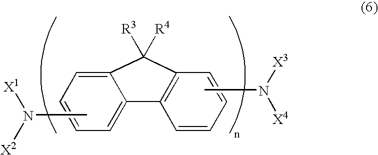
wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; X¹ and X², and X³ and X⁴ may be bonded together to form a ring;
R³ and R⁴ are a group selected from the group consisting of hydrogen, substituted or unsubstituted alkyl, aralkyl and aryl; R³ and R⁴ may be the same or different; R³s or R⁴s bonding different fluorenylene rings may be the same or different; and
n is an integer of 1 to 20.

8. The luminescent ink composition for an organic electroluminescent device according to any one of claims 1 to 6 wherein the condensed aromatic ring compound substituted with an arylamino group is a compound represented by the following formula (7): 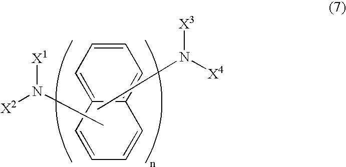
wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; X¹ and X², and X³ and X⁴ may be bonded together to form a ring; and
n is an integer of 1 to 20.

9. The luminescent ink composition for an organic electroluminescent device according to any one of claims 1 to 6 wherein the condensed aromatic ring compound substituted with an arylamino group is a compound represented by the following formula (8): 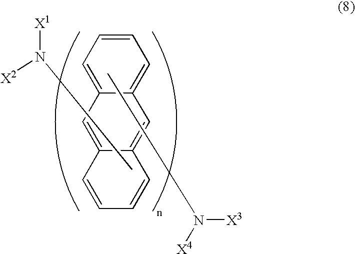
wherein X¹ to X⁴ are a group selected from the group consisting of substituted or unsubstituted alkyl group, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl group having a substituted or unsubstituted arylene group or linking group formed of a divalent heterocyclic group, and carbonyl; X¹ to X⁴ may be the same or different; X¹ and X², and X³ and X⁴ may be bonded together to form a ring; and
n is an integer of 1 to 20.

10. The luminescent ink composition for an organic electroluminescent device according to any one of claims 1 to 6 wherein the condensed aromatic ring compound substituted with an arylamino group is a compound represented by the following formula (9): 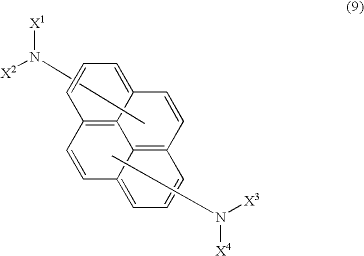
wherein X¹ to X⁴ are a group selected from the group consisting of substituted or unsubstituted alkyl, aralkyl, aryl and heterocycle, substituted or unsubstituted alkenyl having a substituted or unsubstituted arylene group or linking group formed of a divalent heterocyclic group, alkynyl, amino, alkoxy and sulfide, substituted silyl having a substituted or unsubstituted arylene group or linking group formed of a divalent heterocyclic group, and carbonyl; X¹ to X⁴ may be the same or different; and X¹ and X², and X³ and X⁴ may be bonded together to form a ring.

11. The luminescent ink composition for an organic electroluminescent device according to any one of claims 1 to 6 wherein the condensed aromatic ring compound substituted with an arylamino group is a compound represented by the following formula (10): 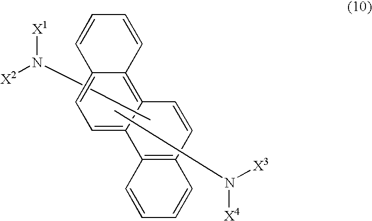
wherein X¹ to X⁴ are a group selected from the group consisting of substituted or unsubstituted alkyl, aralkyl, aryl and heterocycle, substituted or unsubstituted alkenyl group having a substituted or unsubstituted arylene group or linking group formed of a divalent heterocyclic group, alkynyl, amino, alkoxy and sulfide, substituted silyl group having a substituted or unsubstituted arylene group or linking group formed of a divalent heterocyclic group, and carbonyl; X¹ to X⁴ may be the same or different; and X¹ and X², and X³ and X⁴ may be bonded together to form a ring.

12. An organic electroluminescent device comprising an organic thin film produced by using the luminescent ink composition for an organic electroluminescent device of any one of claims 1 to 11.
